(19) United States
(12) Patent Application Publication
(10) Pub. No.: US 2008/0158092 A1
(43) Pub. Date: Jul. 3, 2008

(54) Antenna and semiconductor device having the same

(75) Inventors: Yuto Yakubo, Atsugi (JP); Takaaki Koen, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 12/000,825

(22) Filed: Dec. 18, 2007

(30) Foreign Application Priority Data
Dec. 27, 2006 (JP) 2006-353243

(51) Int. Cl. H01Q 7/00

(52) U.S. Cl. 343/866

(57) ABSTRACT

An antenna for an electromagnetic induction method, in which unevenness in current density distribution is suppressed so that a magnetic field with reduced distortion is generated. In addition, a semiconductor device with less variation in response frequency and communication distance is also provided. The antenna has a loop-like shaped conductive structure with a cut portion in a part thereof and cross-sectional surfaces of the conductive structure face each other in the cut portion. In addition, the conductive structure of the antenna is electrically coupled to have capacity in the cut portion. The semiconductor device has the antenna and an integrated circuit which is connected to the antenna in a power feeding portion.

### BACKGROUND OF THE INVENTION

1. Field of the Invention

The present invention relates to an antenna which transmits and receives information in an electromagnetic induction method and a semiconductor device having the antenna.

2. Description of the Related Art

In recent years, RFID (radio frequency identification) systems have been researched and put into practical use.

RFID refers to a technique of contactless communication in order to store or to read data, between a reader/writer and a semiconductor device capable of wireless information transmission and reception (such a semiconductor device is also called an RFID tag, an ID tag, an IC tag, an IC chip, a wireless tag, an electronic tag, or a wireless chip).

As a communication method of such RFID, a radio wave method or an electromagnetic induction method is mainly used (e.g., see Non-Patent Document 1: illustrated RFID Textbook All about Wireless IC Tags Directed to Ubiquitous Society—, editorial supervisor Junichi KISHIGAMI, first edition, published by ASCII Corporation, Mar., 4th, in 2005, p. 26).

A radio wave method uses a radio wave for transmission of electric power and signals. A frequency band which is mainly used in a radio wave method is a high-frequency range from 300 MHz to 300 GHz. Although a radio wave method has an advantage such that an area in which communication can be carried out is large compared with an electromagnetic induction method, it also has a disadvantage such that the communication thereof is easily adversely affected by an obstruction with high dielectric constant such as water or a human body.

On the other hand, since an electromagnetic induction method uses electromagnetic induction for transmission of electric power and signals, communication thereof is not adversely affected by an obstruction with high dielectric constant; however, a communication distance as long as that of a radio wave method cannot be obtained. In addition, in an electromagnetic induction method, an area in which communication can be carried out with an antenna depends on frequency as well as a size of the antenna. If a loop antenna which is commonly used for an electromagnetic induction method is applied to high-frequency wave communication, a wavelength (0.1 cm to 1 m) of a high-frequency wave (300 MHz to 300 GHz) and the length of the antenna (several centimeters to several tens of centimeters) are almost equal; therefore, current fluctuation in the antenna is caused. Since more stable magnetic field can be generated when a fixed current flows in the antenna, an electromagnetic induction method has not been used in a high-frequency range with a short wavelength.

### SUMMARY OF THE INVENTION

An antenna for an electromagnetic induction method using a high-frequency wave, as described above, has a quite short wavelength which is approximately equal to the length of the antenna; therefore, there arises a problem such that current density distribution in the antenna becomes uneven. For example in a dipole antenna, it is known that a current density is high in a power feeding portion and low in opposing ends. In a loop antenna, this uneven current density distribution creates distortion in a magnetic field.

Accordingly, there occurs a problem such that response frequency and communication distance of a semiconductor device capable of wireless information transmission and reception vary depending on a position and angle of the semiconductor device.

Therefore, the present invention provides an antenna for an electromagnetic induction method, in which unevenness in current density distribution is suppressed so that a magnetic field with reduced distortion can be generated. In addition, the present invention provides a semiconductor device with less variation in response frequency and communication distance.

An aspect of the present invention is an antenna which includes a loop-like shaped conductive structure, a power feeding portion in a part of the loop-like shaped conductive structure, and a cut portion in another part of the loop-like shaped conductive structure. In the cut portion, cross-sectional surfaces of the loop-like shaped conductive structure face each other. In addition, the conductive structure of the antenna is electrically coupled to have capacity in the cut portion. Further, a plurality of the cut portions may be provided.

Another aspect of the present invention is an antenna which includes a power feeding portion, a first conductive structure extending in a direction from the power feeding portion, and a second conductive structure extending in a direction different from the direction of the first conductive structure, from power feeding portion. The antenna has a top view shape of a loop-like shape, regarding an end of the first conductive structure as a starting point and an end of the second conductive structure as an end point. In the antenna, a part of the first conductive structure and a part of the second conductive structure overlap spatially. In a region in which the parts of the first and second conductive structures overlap spatially, the first conductive structure and the second conductive structure are electrically coupled to have capacity. In addition, a plurality of the regions in which the parts of the first and second conductive structures overlap spatially may be provided.

Another aspect of the present invention is a semiconductor device which includes an integrated circuit and an antenna electrically connected to the integrated circuit in a power feeding portion. The antenna has the power feeding portion in a part of the a loop-like shaped conductive structure and a cut portion in another part of the loop-like shaped conductive structure, and cross-sectional surfaces of the conductive structure in the cut portion face each other. In addition, the conductive structure of the antenna is electrically coupled to have capacity in the cut portion. Further, a plurality of the cut portions may be provided.

Another aspect of the present invention is a semiconductor device which includes an integrated circuit having two terminals, and an antenna electrically connected to the integrated circuit. The antenna includes a power feeding portion, a first conductive structure extending in a direction from the power feeding portion, and a second conductive structure extending in a direction different from the direction of the first conductive structure, from power feeding portion. The antenna has a top view shape of a loop-like shape, regarding an end of the first conductive structure as a starting point and an end of the second conductive structure as an end point. In the antenna, a part of the first conductive structure and a part of the second conductive structure overlap spatially. In addition, a plurality of regions in which the parts of the first and second conductive structures overlap spatially may be provided.

The semiconductor device of the present invention can have a structure including an integrated circuit provided with a battery which can be charged with electric power wirelessly from an external portion.

Here, since a top view shape of the conductive layer serving as an antenna is a loop-like shape, a magnetic field can be generated. Typical loop-like shapes include a circular loop, a rectangular loop, a polygonal loop, and the like. Further, a character or a pattern may be included as a part of the loop.

A power feeding portion refers to a region which supplies current to an antenna or receives current from an antenna. Therefore, a conductive layer which forms the antenna may have two connection terminals as a power feeding portion. In addition, the conductive layer which forms the antenna may have a coil as the power feeding portion.

Note that in the present invention, description “being connected” includes the cases where elements are electrically connected and where elements are directly connected. Accordingly, in a structure disclosed in the present invention, another element which enables an electrical connection (e.g., a switch, a transistor, a capacitor element, an inductor, a resistor, or a diode) may be interposed between elements having a predetermined connection relation. Alternatively, the elements may be directly connected without interposing another element therebetween.

An antenna of the present invention is a conductive structure which has a loop-like shape and has a cut portion in addition to a power feeding portion. In the cut portion, cross-sectional surfaces of the conductive structure face each other. Since electric charge can be accumulated in the cut portion, current flowing into the vicinity of the cut portion becomes large. Therefore, unevenness in current distribution in the conductive structure serving as the antenna is reduced, so that a magnetic field with reduced distortion can be generated in electromagnetic wave transmission and reception to and from the antenna. Accordingly, variation in communication distance and response frequency depending on positions of a semiconductor device having the antenna which is held over a reader/writer can be reduced.

Further, the antenna provided according to the present invention does not use a circuit element and is formed only by a conductive material; therefore, the antenna can be formed in one plane. Accordingly, the semiconductor device can be easily thinned and can be mounted over various products.

Further, when parts of the conductive structure which forms the antenna face three-dimensionally, in other words, when parts of the conductive structure overlap spatially, a parallel plate capacitor can be formed, so that capacity in end portions of the conductive structure can be increased. Accordingly, reduction in two-dimensional area of the antenna is possible. In addition, reduction in size of the semiconductor device having the antenna is possible.

Further, the antenna provided according to the present invention can have a capacitive component; therefore, when the size of the antenna is adjusted to a certain frequency, inductance can be small. That is, the length of the antenna can be small and the size can be small.

Further, the antenna provided according to the present invention has a very simple shape and a prototype thereof can be easily manufactured; accordingly, the design thereof is easily changed.

Further, since the antenna provided according to the present invention has a very simple shape, it can be formed for a short time at a low cost and therefore, can be mass produced.

### BRIEF DESCRIPTION OF THE DRAWINGS

FIG. 1 is a top plan view of a mode of an antenna of the present invention;

FIG. 2 is a perspective view illustrating details of a cut portion of an antenna of the present invention;

FIG. 3 is an equivalent circuit diagram of an antenna of the present invention;

FIGS. 4A to 4C are top plan views of a detailed shape of a cut portion of an antenna of the present invention;

FIGS. 5A to 5C are top plan views each illustrating a mode of an antenna of the present invention;

FIGS. 6A and 6B are top plan views each illustrating a mode of an antenna of the present invention;

FIGS. 7A to 7C are a perspective view, a top plan view, and a cross-sectional view each illustrating a shape of a semiconductor device of the present invention;

FIGS. 8A to 8D are cross-sectional views illustrating a manufacturing process of a semiconductor device of the present invention;

FIGS. 9A to 9C are cross-sectional views illustrating a manufacturing process of a semiconductor device of the present invention;

FIGS. 10A and 10B are cross-sectional views illustrating a manufacturing process of a semiconductor device of the present invention;

FIGS. 11A and 11B are cross-sectional views illustrating a manufacturing process of a semiconductor device of the present invention;

FIGS. 12A and 12B are cross-sectional views illustrating a manufacturing process of a semiconductor device of the present invention;

FIGS. 13A to 13C are diagrams each illustrating a calculation result of a current density distribution of an antenna of the present invention;

FIG. 14 is a diagram illustrating a mode of a semiconductor device of the present invention;

FIG. 15 is a diagram illustrating a mode of a semiconductor device of the present invention;

FIGS. 16A to 16H are diagrams each illustrating an application mode of a semiconductor device of the present invention;

FIGS. 17A to 17F are diagrams each illustrating a model of an antenna of the present invention;

FIGS. 18A to 18C are diagrams illustrating a calculation result of an antenna of the present invention; and

FIGS. 19A and 19B are a perspective view and a cross-sectional view illustrating a mode of an antenna of the present invention.

### DETAILED DESCRIPTION OF THE INVENTION

Hereinafter, embodiment modes and an embodiment of the present invention are described with reference to the drawings. The present invention can be carried out in many different modes, and it is easily understood by those skilled in the art that modes and details can be modified in various ways without departing from the purpose and the scope of the present invention. Accordingly, the present invention should not be interpreted as being limited to the description of the embodiment modes and the embodiment. Note that like portions in the drawings for describing embodiment modes and embodiments are denoted by the like reference numerals and repeated explanations thereof are omitted.

Generally, antennas can be used for both transmission and reception of radio waves. For simplification, the following embodiment modes describe only cases where an antenna receives a radio wave, and a case where an antenna transmits a radio wave is omitted. However, it is obvious that the antenna of the present invention can also transmit radio waves.

### EMBODIMENT MODE 1

In this embodiment mode, a mode of an antenna of the present invention is described with reference to the drawings.

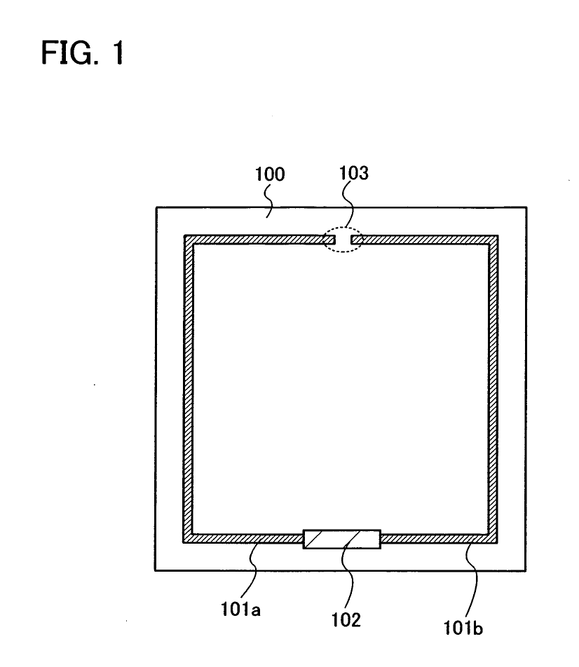

An antenna described in this embodiment mode includes a substrate 100, a conductive structure 101a and a conductive structure 101b, a power feeding portion 102, and a cut portion 103, as shown in FIG. 1. The antenna has a region in which an end portion of the conductive structure 101a and an end portion of the conductive structure 101b face each other. Note that the substrate 100 is not necessary in some cases. The antenna may only include, for example, the conductive structure 101a, the conductive structure 101b, the power feeding portion 102, and the cut portion 103.

The antenna in this embodiment mode is used for an electromagnetic induction method. In the electromagnetic induction method, change in a magnetic field generated by an antenna is converted into current. Therefore, when the antenna has a loop-like shape, the number of magnetic fluxes can be increased, and current flowing into the antenna can also be increased. Accordingly, as shown in FIG. 1, the conductive structure 101 preferably has a loop-like shape including the cut portion 103 and the power feeding portion 102.

The longer the length of the antenna which has one end of the power feeding portion 102 as a starting point, passes through the conductive structure 101a, the cut portion 103, and the conductive structure 101b, and has the another end of the power feeding portion 102 as an end point, that is, the larger the diameter of the loop; the more an area surrounded by the loop is increased. Therefore, the inductivity is enhanced and more magnetic fluxes pass through the area surrounded by the loop. Accordingly, more current flows. Further, when the length of the antenna does not change, change in shapes of the conductive structures 101a and 101b can enhance or decrease the inductivity of the antenna.

Note that, in the case of an antenna which resonates at a high-frequency wave (typically, 300 MHz to 300 GHz), the length of the antenna is preferably several millimeters to several meters, typically, 1 mm to 1 m.

Hereinafter, the conductive structure 101 refers to both the conductive structure 101a and the conductive structure 101b unless otherwise specified.

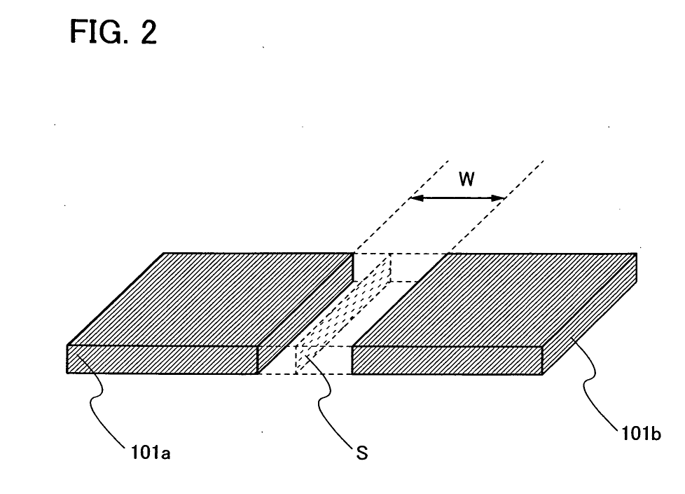

FIG. 2 shows an enlarged view of the cut portion 103. A width W of the cut portion and an area S of a facing area of the conductive pattern are optimized so that the cut portion 103 has capacity. The capacity can be enhanced when the width W of the cut portion is small, a relative dielectric constant in the cut portion is high, and the area S of the facing area of the conductive pattern is increased.

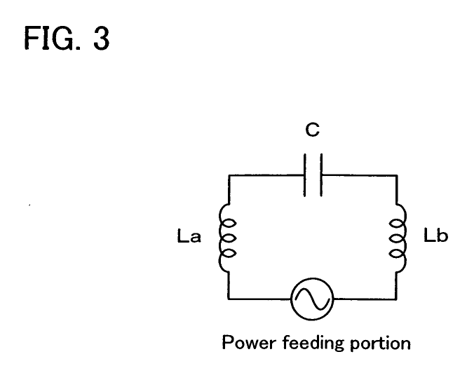

FIG. 3 shows an equivalent circuit in this embodiment mode shown in FIG. 1.

In the equivalent circuit shown in FIG. 3, when impedance of an external element does not have an imaginary part, the resonance frequency f is expressed by the expression 1. Values of an inductor La of the conductive structure 101a, an inductor Lb of the conductive structure 101b, and a capacitor C including the cut portion are greatly affected by shapes of the conductive structure 101a, the conductive structure 101b, and the cut portion 103, respectively. Therefore, by adjusting the shapes of the conductive structure 101a, the conductive structure 101b, and the cut portion 103, the antenna can be in a resonance.

$$f = \frac{1}{2 π \sqrt{( La + Lb ) C}} \qquad ( expression 1 )$$

On the other hand, when an impedance of an external element has an imaginary part X, the shapes of the conductive structure 101a, the conductive structure 101b, and the cut portion 103 are adjusted to satisfy expression 2. By this, the imaginary part in the impedance of an external element can be canceled, and the antenna can be in a resonance.

$$- X = 2 π f ( La + Lb ) - \frac{1}{2 π fC} \qquad ( expression 2 )$$

When the length of the loop antenna is larger than a certain length with respect to a wavelength (e.g., longer than or equal to 1% of the wavelength), unevenness is caused in current density distribution in the antenna and a magnetic field is distorted. This unevenness can be relieved by capacity of the cut portion 103. When capacity of the cut portion 103 is small, only a small amount of electric charge can be accumulated in the vicinity of the cut portion 103; accordingly, small current flows into the cut portion 103. On the other hand, when the capacity of the cut portion 103 is large, a large amount of electric charge is accumulated in the vicinity of the cut portion 103; accordingly, large current flows into the vicinity or the cut portion 103. Thus, current density distribution in the antenna becomes even. When the capacity of the cut portion 103 is large, the evenness in the current density distribution can be further enhanced.

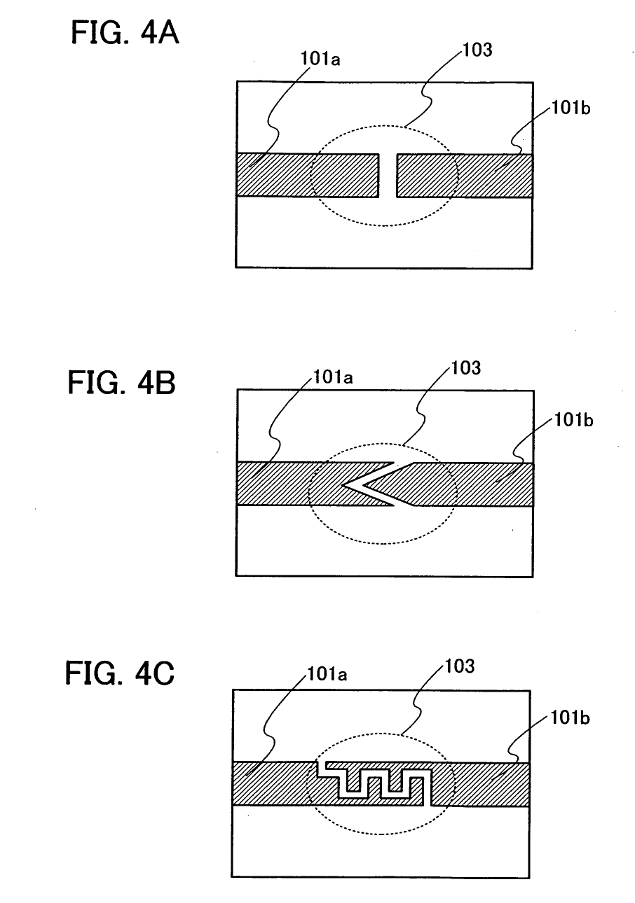

Then, a top plan view shape of the cut portion is described with reference to FIGS. 4A to 4C. Note that the cut portion here does not necessarily refer to a region in which a continuous conductive structure is actually cut. The cut portion typically refers to a region in a loop-like shaped conductive structure in which ends of a conductive structure face each other with a certain distance therebetween. The entire parts of the ends do not necessary face and parts thereof may face each other. the conductive structure is seen from above, a shape of the cut portion is a straight line. In addition, one pair of surfaces in the ends of the conductive structure faces. The structure of the cut portion 103 having such a shape is easy to be formed and therefore suitable for mass production.

In FIG. 4B, when the conductive structure is seen from above, the shape of the cut portion 103 is a V-shape. In addition, two pairs of surfaces in the ends of the conductive structure face. The cut portion 103 having such a shape has large capacity and current density distribution becomes further even.

In FIG. 4C, when the conductive structure is seen from above, the shape of the cut portion 103 is a comb-shape. In addition, a plurality of pairs in the ends of the conductive structure face. When the cut portion 103 has such a shape, an area which forms a part having capacity can be enlarged; so that capacity in the cut portion 103 is enlarged and current density distribution can be further even. The cut portion 103 in FIG. 4C has a complex shape and an area which forms a part having capacity is enlarged; therefore, current density distribution can be further even compared with FIGS. 4A and 4B.

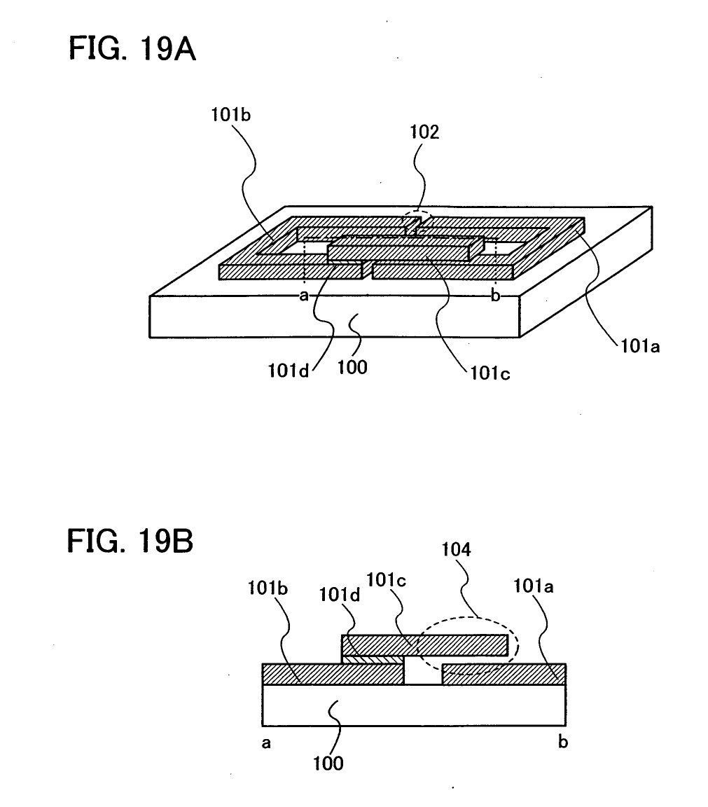

When parts of a conductive structure which forms an antenna overlap three-dimensionally as shown in FIGS. 19A and 19B, in other words, when the parts of the conductive structure which forms an antenna overlap spatially, a parallel plate capacitor can be formed. FIG. 19A shows an antenna formed over the substrate 100 including the conductive structures 101a and 10b which extend in opposing directions from the power feeding portion 102. The conductive structure 101b is connected to a conductive structure 101c through a conductor 101d. The conductive structure 101c and the conductive structure 101a keep a certain distance therebetween.

FIG. 19B shows a cross-sectional view taken along the line a-b in FIG. 19A. The conductive structure 101a and the conductive structure 101c overlap with a certain distance therebetween, that is, the conductive structure 101a and the conductive structure 101c overlap three-dimensionally. In an overlapping portion 104, a parallel plate capacitor can be formed. Accordingly, the overlapping portion 104 can have larger capacity than the cut portions in FIGS. 4A to 4C. As a result, a two-dimensional area of the antenna can be reduced.

The above-described shapes of the cut portion 103 are just examples. The shape of the cut portion 103 can employ many different modes. It is easily understood by those skilled in the art that modes and details can be modified in various ways without departing from the purpose and the scope of the present invention. Accordingly, the present invention should not be interpreted as being limited to the description of this embodiment mode.

Note that the single conductive structure 101 may include a plurality of cut portions 103 or a plurality of overlapping portions 104.

A position of the cut portion 103 where the conductive structure 101 is cut is not limited to a place described above. The cut portion 103 may be provided in any place of the conductive structure 101, as long as resonance frequency is satisfied. Note that when the cut portion is in an opposite side of the power feeding portion when the conductive structure is seen from above, a large amount of electric charge is generated and accumulated in the cut portion and capacity can be increased.

Next, a shape of a conductive structure is described below.

Although the conductive structure 101 is a square divided into the conductive structure 101a and the conductive structure 101b by the cut portion 103, the conductive structure 101 is not limited to a square having a cut portion as a part. For example, the conductive structure 101 may have a polygonal shape or may have rounded corners. When the conductive structure 101 may have a polygonal shape or may have rounded corners, evenness in current distribution in a corner is reduced. Therefore, advantageous effect is obtained such that loss of electric power in the conductive structure 101 is reduced.

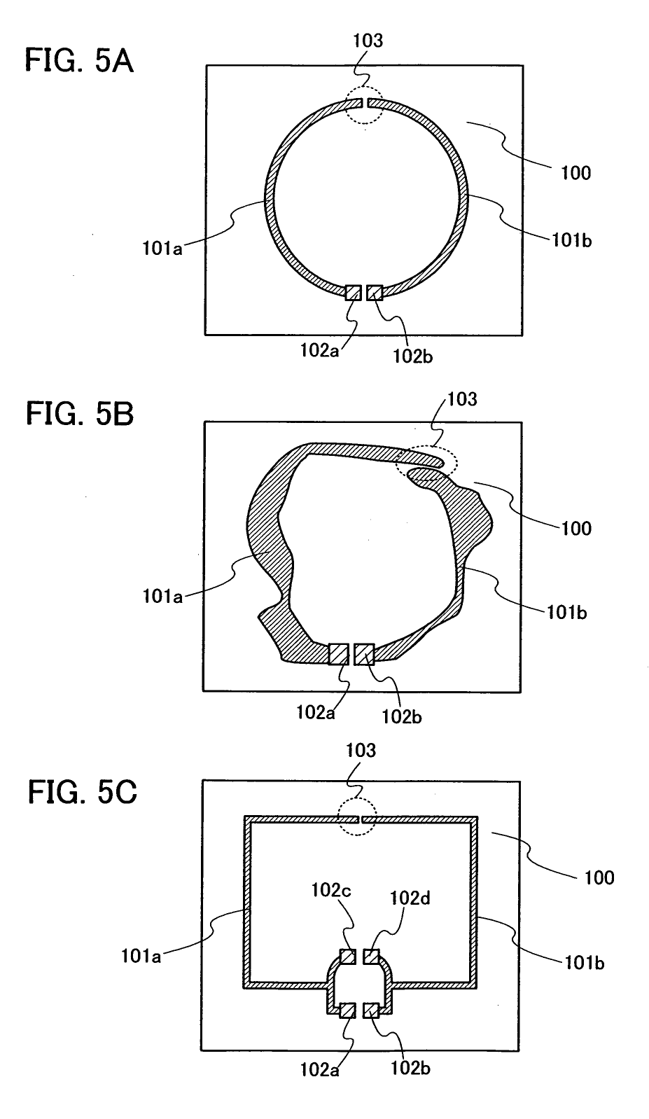

For example, as shown in FIG. 5A, the conductive structure 101 may have a circular shape divided into the conductive structure 101a and the conductive structure 101b by the cut portion 103 and the power feeding portions 102a and 102b. Although a case in which the conductive structure 101 has a circular shape divided into the conductive structure 101a and the conductive structure 101b by the cut portion 103 and the power feeding portions 102a and 102b, the shape of the conductive structure 101 is not limited thereto. For example, the conductive structure 101 may have an elliptical shape or may have corners. When the conductive structure 101 is provided for the substrate 100 and an object, flexibility in a providing manner is increased with the conductive structure 101 having an elliptical shape or having corners.

As shown in FIG. 5B, the conductive structure 101 may have uneven width and thickness. Since the shape of the conductive structure 101 affects reactance of the antenna, when width and thickness of the conductive structure 101 vary in different parts, resonance frequency of the antenna can be adjusted, or resonance sharpness in accordance with frequency can be adjusted.

As shown in FIG. 5C, the conductive structure 101 may have a structure in which a part of the conductive structure 101 is branched. When parts of the conductive structures 101a and 101b are branched and plural pairs of power feeding portions having different distances from a cut portion are provided for the conductive structure, an antenna having a plurality of resonance frequency can be manufactured. In specific, the length of the antenna is different between a case in which a chip is connected to the power feeding portions 102a and 102b, and a case in which a chip is connected to the power feeding portions 102c and 102d. Therefore, a single antenna can have a plurality of frequency.

The conductive structure 101 may have any shape as long as it is a loop-like shape and includes the substrate 100, the power feeding portion 102, and the cut portion 103, which are described in this embodiment mode. For example, a loop-like shape in which the shape of the conductive structure 101 looks like a character or a pattern may be employed. When the conductive structure 101 has a shape in which a part thereof looks like a character or a pattern, an antenna which can harmonize with surroundings can be manufactured. Further, when the antenna has a logotype or the like of a company, the antenna is an advertising effect can be obtained.

The conductive structure 101 is not limited to an antenna provided in one plane. For example, the number of turns of the conductive structure 101 may be increased like a coil. When a winding number is increased, change in magnetic flux in the antenna can be more efficiently converted into current in the conductive structure 101. In addition, the antenna can be reduced in size.

The conductive structure 101 can be formed of a conductive material such as copper (Cu), aluminum (Al), silver (Ag), gold (Au), or nickel (Ni). Alternatively, stacked layers of any of those conductive materials can be formed for the conductive structure 101, for example, a stack-layer structure including copper, nickel, and gold may be employed.

A material may be provided for a part surrounded by the loop of the conductive structure 101. When a material, for example, ferrite or amorphous metal, which can enhance magnetic flux density, is provided, a change in magnetic flux in the loop can be more efficiently converted into current in the conductive structure 101.

Next, the power feeding portion 102 which supplies electric power to an antenna is described below.

The power feeding portion 102 is a portion which receives or transmits electric power from or to an external element. The power feeding portion 102 may have any structure which achieves the purpose. The power feeding portion 102 has a width and a thickness, which are different from those of the conductive structure 101. When the width of the power feeding portion 102 is larger than that of the conductive structure 101, flexibility in a way of connection with an external element is increased without a change in resonance frequency. Further, when the thickness of the conductive structure 101 is small, the power feeding portion 102 can be wider than the conductive structure 101.

Note that the boundary between the conductive structure 101 and the power feeding portion 102 is not clearly defined. Accordingly, a part of the conductive structure 101 may be defined as the power feeding portion 102. In this specification, a part of the conductive structure 101 is defined as the power feeding portion 102 unless otherwise specified.

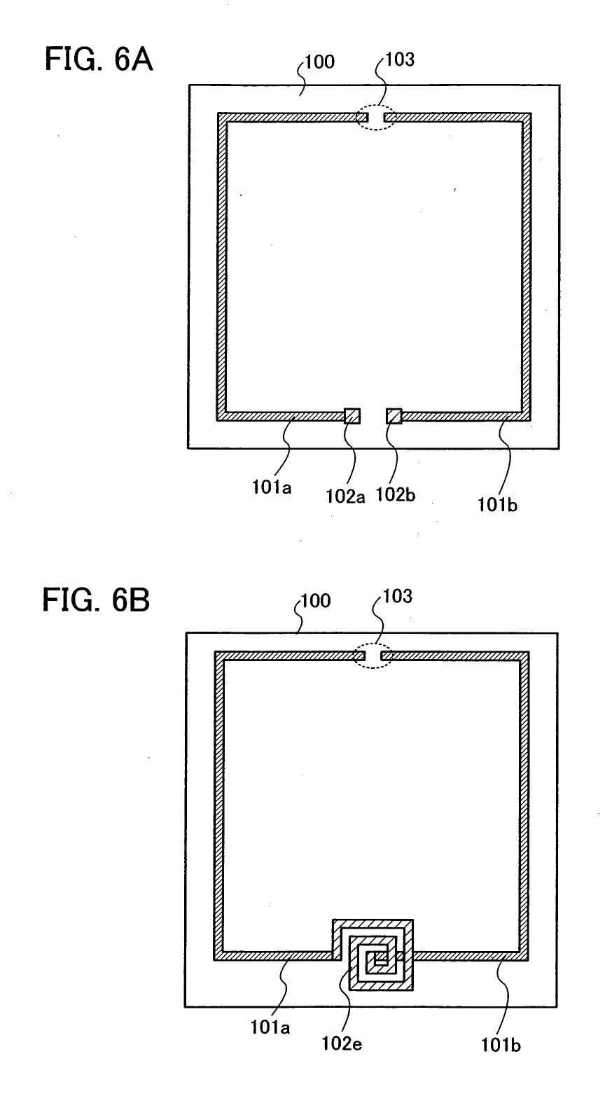

As shown in FIG. 6A, the power feeding portions 102a and 102b may be different connection terminals.

A structure may be employed in which the conductive structure 101a and the power feeding portion 102a are electrically connected and the conductive structure 101b and the power feeding portion 102b are electrically connected.

Alternatively, as shown in FIG. 6B, a coil 102e which can generate a magnetic field in a vertical direction of the substrate may be provided as a power feeding portion. Further, in the case of a structure in which an external element itself generates a magnetic field for the antenna, the antenna can transmit or receive electric power to or from the external element by electromagnetic induction, so that a part of the conductive structure serves as the power feeding portion without providing additional connection terminal or coil. Accordingly, the power feeding portion 102 is not necessarily divided into the power feeding portion 102a and the power feeding portion 102b unlike FIG. 6A, and the power feeding portion 102a and the power feeding portion 102b may be electrically connected.

A material of the power feeding portion 102 and a material of the conductive structure 101 may be the same or different.

Next, the substrate 100 is described.

The substrate 100 is provided for various purposes. The purposes include, but not limited to, to keeping a positional relationship among the conductive structure 101a, the conductive structure 101b, and surroundings, shortening a wavelength of electromagnetic wave in the conductive structure 101, and enhancing magnetic flux density in the conductive structure.

When a relative dielectric constant of the substrate 100 is larger than 1, a wavelength shortening effect is obtained in which a wavelength on an emission side is shorter than the incidence side when the electromagnetic wave on the incidence side and on the emission side are compared. Therefore, in the air, when the relative dielectric constant of the substrate 100 is larger than that of the air (typically, when the relative dielectric constant of the substrate 100 is larger than 1), a wavelength can be shortened; accordingly, the antenna can be small size compared with the case without the substrate 100.

The shape of the substrate 100 is not limited to a square shown in FIG. 1. In addition, the thickness of the substrate 100 may be uneven. That is, the shape of the substrate 100 can be determined freely in accordance with the surroundings and usage. Here, the shape of the substrate 100 which can be freely determined includes a character, a pattern, a circle, a polygon, a shape similar to the conductive structure 101, or a shape which covers the conductive structure 101. When the conductive structure 101 is covered with the substrate 100, a structure in which the conductive structure 101 is not in contact with external environment can be employed.

For the substrate 100, a dielectric material such as a glass epoxy resin, a fluorine resin, ceramics, polyethylene terephthalate (PET), polyethylene naphthalate (PEN), polyether sulfone (PES), acrylic, or paper can be used.

Different materials can be used for different parts of the substrate 100. For example, when a magnetic material such as ferrite is used in a part of the substrate 100 which is surrounded by the loop of the conductive structure 101, a change in magnetic flux in the loop of the conductive structure 101 can be increased.

As described above, the antenna in this embodiment mode has a loop-like shape and has a cut portion in addition to a power feeding portion. Since electric charge can be accumulated in the cut portion, the amount of current flowing into the vicinity of the cut portion is increased. Therefore, unevenness in current density distribution in the conductive structure of the antenna is reduced, so that a magnetic field with reduced distortion can be generated in electromagnetic wave transmission or reception to or from the antenna.

### EMBODIMENT MODE 2

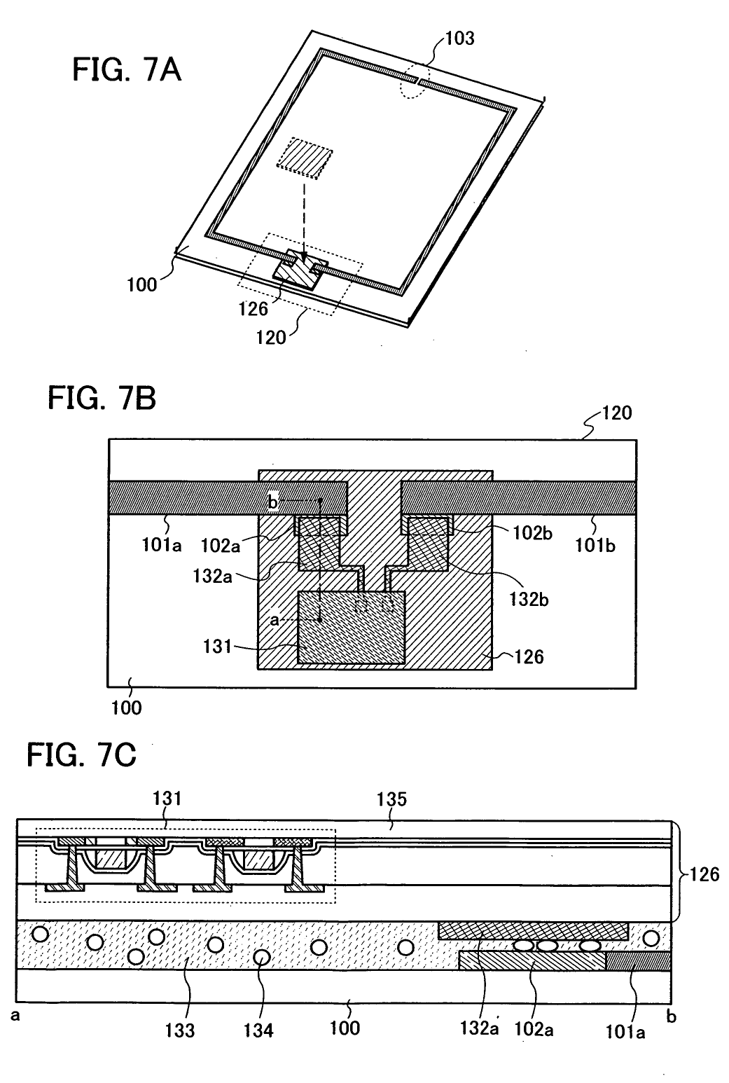

This embodiment mode describes a semiconductor device having the antenna described in the foregoing embodiment mode with reference to FIGS. 7A to 7C. Specifically, description is made of the case where a semiconductor device is formed by attaching an element layer (also called an IC chip) having elements such as transistors to the antenna described in the foregoing embodiment mode. FIG. 7B is an enlarged view of a region 120 in FIG. 7A, and FIG. 7C is a cross-sectional view along the line a-b in FIG. 7B.

First, the conductor structures 101a and 101b serving as an antenna and the power feeding portions 102a and 102b are formed over the substrate 100. Meanwhile, an element layer 126 having elements such as transistors is formed separately from the antenna. For the antenna, an antenna having any structure described in the foregoing embodiment mode may be employed. The element layer 126 includes an integrated circuit portion 131 having elements such as transistors and conductive films 132a and 132b electrically connected to the integrated circuit portion 131 (see FIG. 7B).

Next, the element layer 126 is attached to the substrate 100 (see FIG. 7A). The element layer 126 is attached to the substrate 100 so that the power feeding portions 102a and 102b formed over the substrate 100 are electrically connected to the conductive films 132a and 132b formed in the element layer 126, respectively. Here, the case is shown in which an anisotropic conductive adhesive is used for attaching the element layer 126 to the substrate 100 (see FIG. 7C), and the element layer 126 is attached to the substrate 100 using an adhesive resin 133. In addition, the power feeding portions 102a and 102b are electrically connected to the conductive films 132a and 132b, respectively, using conductive particles 134 contained in the adhesive resin 133. Attachment of the element layer 126 to the substrate 100 can be carried out with a conductive adhesive such as silver paste, copper paste, or carbon paste, by solder reflow, or the like.

Thin film transistors (TFFs) may be provided in the integrated circuit portion 131 of the element layer 126. In this case, a glass substrate or a plastic substrate may be used as a substrate 135 of the element layer 126. Alternatively, it is also possible to use a semiconductor substrate such as silicon (Si) for the substrate 135 and form field-effect transistors whose channel regions are provided in the semiconductor substrate, so that the integrated circuit portion 131 can include the field-effect transistors.

The semiconductor device of this embodiment mode can employ any of the structures of an antenna, any of the methods of a semiconductor device, and the like that are described in other embodiment modes of this specification.

Although description is made of the case of using a semiconductor device capable of transmitting and receiving information wirelessly in this embodiment mode, the antenna described in Embodiment Mode 1 can be used as an antenna of a reader/writer.

An antenna used for the semiconductor device of this embodiment mode has a loop-like shape and has a cut portion in addition to a power feeding portion in its conductive structure. Since electric charge can be accumulated in the cut portion, current flowing into the vicinity of the cut portion becomes large. Therefore, unevenness in current density distribution in the conductive structure serving as the antenna is reduced, so that a magnetic field with reduced distortion can be generated in electromagnetic wave transmission and reception to and from the antenna. Accordingly, with the semiconductor device described in this embodiment mode, variation in communication distance and response frequency depending on positions of the semiconductor device with respect to another antenna can be reduced.

### EMBODIMENT MODE 3

This embodiment mode describes a method of manufacturing the semiconductor device described in Embodiment Mode 2, with reference to drawings. In this embodiment mode, description is made of the case where an element layer is formed by providing elements such as transistors over a flexible substrate.

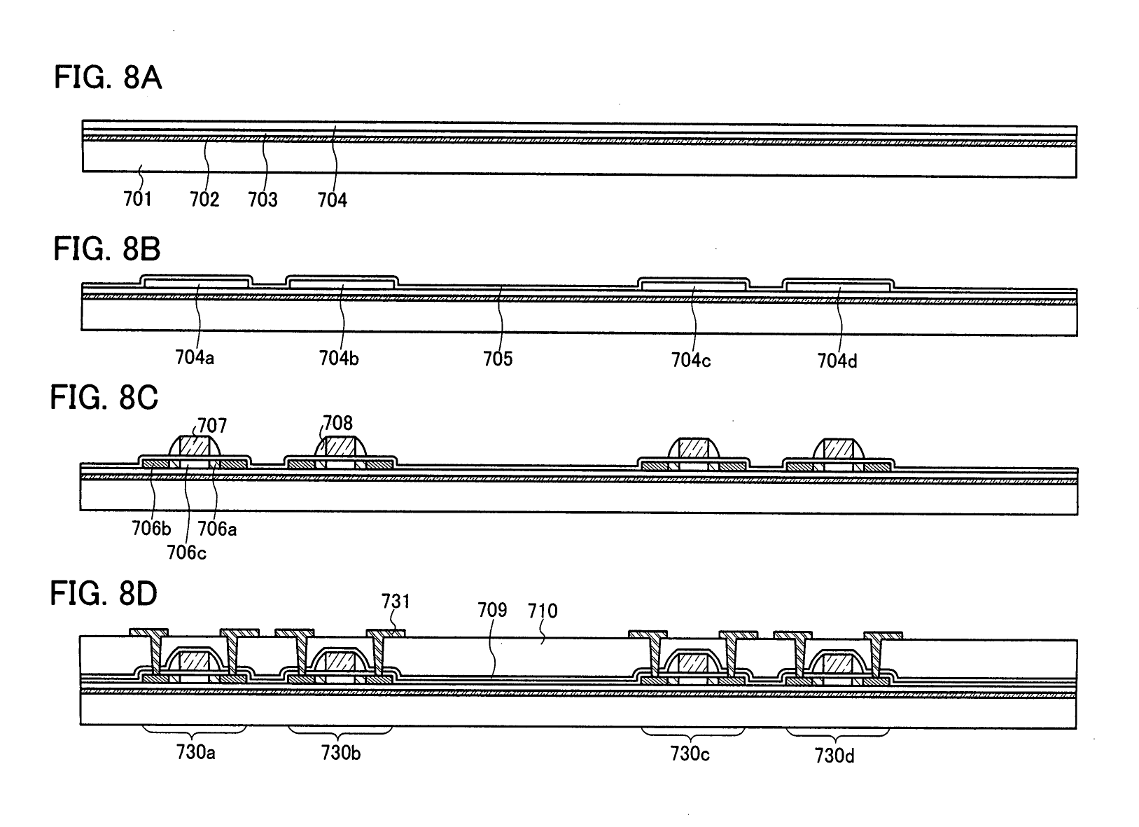

First, a release layer 702 is formed over a surface of a substrate 701. Then, an insulating film 703 serving as a base and an amorphous semiconductor film 704 (e.g., a film containing amorphous silicon) are formed thereover (see FIG. 8A). Note that the release layer 702, the base insulating film 703, and the amorphous semiconductor film 704 can be formed consecutively.

The substrate 701 may be a glass substrate, a quartz substrate, a metal substrate, or a stainless steel substrate that has an insulating film formed over its surface, a thermally stable plastic substrate that can withstand the processing temperature during the manufacturing process, or the like. When such a substrate is used for the substrate 701, the area and the shape thereof are not particularly limited. Therefore, when a rectangular substrate with at least one meter on a side is used, productivity can be significantly improved. This is a great advantage compared to the case of using a circular silicon substrate. In this manufacturing process, although the release layer 702 is provided over the entire surface of the substrate 701, the release layer 702 may be provided selectively by a photolithography method as needed after the release layer 702 is provided over the entire surface of the substrate 701. Further, although the release layer 702 is formed to be in contact with the substrate 701, it is also possible to form a base insulating film to be in contact with the substrate 701 and then form the release layer 702 to be in contact with the base insulating film.

The release layer 702 may be formed using a metal film or a stack-layer structure of a metal film and a metal oxide film. As a metal film, a single layer or stacked layers are formed using an element selected from tungsten (W), molybdenum (Mo), titanium (Ti), tantalum (Ta), niobium (Nb), nickel (Ni), cobalt (Co), zirconium (Zr), zinc (Zn), ruthenium (Ru), rhodium (Rh), palladium (Pd), osmium (Os), or iridium (Ir), or an alloy material or a compound material containing such an element as a main component. The metal film can be formed by various film forming methods such as a sputtering method, a plasma CVD method, or the like. A stack-layer structure of the metal film and the metal oxide film can be obtained by the steps of forming the foregoing metal film and then applying plasma treatment or thermal treatment thereto under an oxygen atmosphere or an N₂O atmosphere, thus, oxide or oxynitride of the metal film can be formed on a surface of the metal film. For example, when a tungsten film is provided as the metal film by a sputtering method, a CVD method, or the like, a metal oxide film formed of tungsten oxide can be formed on the surface of the tungsten film by applying plasma treatment to the tungsten film. In this case, tungsten oxide is expressed by WOₓ, where X is 2 to 3. There are cases where x is 2 (WO₂), x is 2.5 (W₂O₅), x is 2.75 (W₄O₁₁), x is 3 (WO₃), and the like. In forming tungsten oxide, there is no particular limitation on the value of the foregoing X, and which kind of oxide is to be formed may be determined in accordance with the etching rate or the like. Alternatively, for example, a metal film (e.g., tungsten) may be formed, then, an insulating film of silicon oxide (SiO₂) or the like may be formed over the metal film by a sputtering method, so that a metal oxide is also formed on the metal film (e.g., tungsten oxide over tungsten).

The insulating film 703 is formed in a single layer or stacked layers by forming a film containing silicon oxide or silicon nitride by a sputtering method, a plasma CVD method, or the like. In the case where the insulating film serving as a base is formed to have a two-layer structure, for example, a silicon nitride oxide film and a silicon oxynitride film may be formed as a first layer and a second layer, respectively. In the case where the insulating film serving as a base is formed to have a three-layer structure, a silicon oxide film, a silicon nitride oxide film, and a silicon oxynitride film may be formed as first to third insulating films, respectively. Alternatively, a silicon oxynitride film, a silicon nitride oxide film, and a silicon oxynitride film may be formed as the first to third insulating films, respectively. The insulating film serving as a base serves as a blocking film for preventing intrusion of impurities from the substrate 701.

The amorphous semiconductor film 704 is formed to have a thickness of 25 to 200 nm (preferably, 30 to 150 nm) by a sputtering method, an LPCVD method, a plasma CVD method, or the like.

Next, the amorphous semiconductor film 704 is crystallized, for example, by a laser crystallization method, a thermal crystallization method using RTA or an annealing furnace, a crystallization method using a metal element that promotes crystallization, or a method combining a crystallization method using a metal element that promotes crystallization and a laser crystallization method, whereby a crystalline semiconductor film is formed. Then, the crystalline semiconductor film which is obtained is etched into desired shapes, thus, crystalline semiconductor films 704a to 704d are formed. Then, a gate insulating film 705 is formed so as to cover the crystalline semiconductor films 704a to 704d (see FIG. 8B).

An example of a manufacturing process of the crystalline semiconductor films 704a to 704d is briefly described below. First, an amorphous semiconductor film is formed by a plasma CVD method to have a thickness of 50 to 60 nm. Then, a solution containing nickel, which is a metal element for promoting crystallization, is retained on the amorphous semiconductor film, which is followed by dehydrogenation treatment (500° C. for one hour) and thermal treatment (550° C. for four hours). Thus, a crystalline semiconductor film is formed. Then, the crystalline semiconductor film is irradiated with laser light and processed by a photolithography method; thus, the crystalline semiconductor films 704a to 704d are formed.

When the crystalline semiconductor films are formed by a laser crystallization method, either continuous wave laser beams (CW laser beams) or pulsed laser beams can be used. Laser beams that can be used here include those emitted from gas lasers such as an Ar laser, a Kr laser, and an excimer laser; a laser in which single-crystalline YAG, YVO₄, forsterite (Mg₂SiO₄), YAlO₃, or GdVO₄ or polycrystalline (ceramic) YAG, Y₂O₃, YVO₄, YAlO₃, or GdVO₄, doped with one or more laser media selected from Nd, Yb, Cr, Ti, Ho, Er, Tm, or Ta; a glass laser; a ruby laser; an alexandrite laser; a Ti:sapphire laser; a copper vapor laser; and a metal vapor laser. When irradiation is carried out with the fundamental wave of such laser beams or the second to fourth harmonics of the fundamental wave, crystals with a large grain size can be obtained. For example, the second harmonic (532 nm) or the third harmonic (355 nm) of an Nd:YVO₄ laser (a fundamental wave of 1064 nm) can be used. In this case, a laser power density of about 0.01 to 100 MW/cm² (preferably, 0.1 to 10 MW/cm²) is needed, and irradiation is conducted with a scanning rate of about 10 to 2000 cm/sec. Note that the laser in which single-crystalline YAG, YVO₄, forsterite (Mg₂SiO₄), YAlO₃, or GdVO₄ or polycrystalline (ceramic) YAG, Y₂O₃, YVO₄, YAlO₃, or GdVO₄ is doped with one or more laser media selected from Nd, Yb, Cr, Ti, Ho, Er, Tm, or Ta as dopant; an Ar ion laser; or a Ti:sapphire laser can be used as a CW laser, whereas they can also be used as pulsed laser with a repetition rate of 10 MHz or more by being combined with a Q-switch operation or mode locking. When a laser beam with a repetition rate of 10 MHz or more is used, it is possible for a semiconductor film to be irradiated with the next pulse after it is melted by the previous laser and before it becomes solidified. Therefore, unlike the case of using a pulsed laser with a low repetition rate, a solid-liquid interface in the semiconductor film can be continuously moved. Thus, crystal grains that have grown continuously in the scanning direction can be obtained.

In addition, when the amorphous semiconductor film is crystallized by using a metal element that promotes crystallization, there are advantages in that crystallization can be conducted at a low temperature in a short time and the direction of crystals can be uniform, whereas there are also disadvantages in that the metal element remains in the crystalline semiconductor films, which may result in increased off-current and unstable characteristics. Therefore, it is preferable to form an amorphous semiconductor film serving as a gettering site over the crystalline semiconductor films. The amorphous semiconductor film to serve as a gettering site should contain an impurity element such as phosphorus or argon. Therefore, such an amorphous semiconductor film is preferably formed by a sputtering method to contain a high concentration of argon. Then, thermal treatment (e.g., thermal annealing using an RTA method or an annealing furnace) is applied, so that the metal element is diffused into the amorphous semiconductor film, and then the amorphous semiconductor film containing the metal element is removed. Accordingly, the metal element contained in the crystalline semiconductor films can be reduced or removed.

Next, the gate insulating film 705 which covers the crystalline semiconductor films 704a to 704d is formed. The gate insulating film 705 is formed in a single layer or stacked layers by forming a film containing silicon oxide or silicon nitride by a CVD method, a sputtering method, or the like. Specifically, the gate insulating film 705 is formed in a single layer or stacked layers by forming any of film containing silicon oxide, a film containing silicon oxynitride, and a film containing silicon nitride oxide.

The gate insulating film 705 may also be formed by oxidizing or nitriding surfaces of the crystalline semiconductor films 704a to 704d by high-density-plasma treatment. For example, plasma treatment with a mixed gas of a rare gas such as He, Ar, Kr, or Xe, and oxygen, nitrogen oxide (NO₂), ammonia, nitrogen, or hydrogen is used. When plasma is excited by the introduction of microwaves, plasma with a low electron temperature and a high electron density can be generated. With oxygen radicals (which may also include OH radicals) or nitrogen radicals (which may also include NH radicals) that are produced by the high-density plasma, the surfaces of the crystalline semiconductor films can be oxidized or nitrided.

By such high-density-plasma treatment, an insulating film with a thickness of 1 to 20 nm, typically 5 to 10 nm, is formed on the semiconductor films. Since the reaction in this case is a solid-phase reaction, interface state density between the insulating film and the semiconductor films can be made quite low. Also, since such high-density-plasma treatment directly oxidizes (or nitrides) semiconductor films (crystalline silicon or polycrystalline silicon), the insulating film to be formed can have a uniform thickness, ideally. Further, since crystal grain boundaries of crystalline silicon are not strongly oxidized, an excellent state can be obtained. That is, by the solid-phase oxidation of the surfaces of the semiconductor films through the high-density-plasma treatment described in this embodiment mode, an insulating film with a uniform thickness and low interface state density can be formed without excessive oxidation at the crystal grain boundaries.

As the gate insulating film, only an insulating film formed by high-density-plasma treatment may be used, or it is also possible to deposit another insulating film of, for example, silicon oxide, silicon oxynitride, or silicon nitride over the above-mentioned insulating film by a CVD method using plasma or thermal reaction. In any case, a transistor which has an insulating film formed by high-density-plasma treatment in a part or the whole of the gate insulating film can have small variations in characteristics.

The crystalline semiconductor films 704a to 704d which are obtained by crystallizing a semiconductor film by laser beam irradiation of a continuous wave laser or a laser with a repetition rate of 10 MHz or more while scanning in one direction has a characteristic that crystals thereof grow in the scanning direction of the beam. Therefore, a transistor is placed so that the scanning direction is the same as the channel length direction (the flowing direction of carriers in a channel forming region), and then the foregoing gate insulating layer is combined. In such a manner, a thin film transistor (TFr) with small variations in characteristics and a high electron field-effect mobility can be realized.

Next, a first conductive film and a second conductive film are stacked over the gate insulating film 705. Here, the first conductive film is formed to have a thickness of 20 to 100 nm by a plasma CVD method, a sputtering method, or the like. The second conductive film is formed to have a thickness of 100 to 400 nm. The first conductive film and the second conductive film are formed with an element selected from tantalum (Ta), tungsten (W), titanium (Ti), molybdenum (Mo), aluminum (Al), copper (Cu), chromium (Cr), niobium (Nb), or the like, or an alloy material or a compound material containing such an element as a main component. Alternatively, the first conductive film and the second conductive are formed using a semiconductor material typified by polycrystalline silicon doped with an impurity element such as phosphorus. As combination examples of the first conductive film and the second conductive film, a tantalum nitride film and a tungsten film; a tungsten nitride film and a tungsten film; a molybdenum nitride film and a molybdenum film; and the like can be given. Tungsten and tantalum nitride have high heat resistance. Therefore, after forming the first conductive film and the second conductive film using tungsten and tantalum nitride, thermal treatment can be applied thereto for the purpose of thermal activation. In addition, in the case where a three-layer structure is employed instead of a two-layer structure, it is preferable to form a stack-layer structure of a molybdenum film, an aluminum film, and a molybdenum film.

Next, a resist mask is formed by a photolithography method, and etching treatment for forming gate electrodes and gate lines is applied. Thus, gate electrodes 707 are formed above the crystalline semiconductor films 704a to 704d.

Next, a mask formed of resist is formed by a photolithography method and the crystalline semiconductor films 704a to 704d are doped with an impurity element which imparts n-type conductivity by an ion doping method or an ion implantation method at a low concentration. As the impurity element which imparts n-type conductivity, a Group 15 element such as phosphorus (P) or arsenic (As) may be used.

Next, an insulating film is formed so as to cover the gate insulating film 705 and the gate electrodes 707. The insulating film is formed in a single layer or stacked layers by forming a film containing an inorganic material such as silicon, silicon oxide, or silicon nitride, or a film containing an organic material such as an organic resin by a plasma CVD method, a sputtering method, or the like. Next, the insulating film is selectively etched by anisotropic etching in which etching is conducted mainly in the perpendicular direction, thus, insulating films 708 (also called sidewalls) that are in contact with the side surfaces of the gate electrodes 707 are formed. The insulating films 708 are used as doping masks for forming lightly doped drain (LDD) regions in a subsequent step.

Next, the crystalline semiconductor films 704a to 704d are doped with an impurity element which imparts n-type conductivity at a low concentration using a mask formed of resist by a photolithography method using the gate electrodes 707 and the insulating films 708 as masks. Thus, first n-type impurity regions 706a (also called LDD regions), second n-type impurity regions 706b, and channel regions 706c are formed (see FIG. 8C). The concentration of the impurity element contained in the first n-type impurity region 706a is lower than the concentration of the impurity element contained in the second n-type impurity region 706b.

Next, an insulating film is formed in a single layer or stacked layers so as to cover the gate electrodes 707, the insulating films 708, and the like, whereby thin film transistors 730a to 730d are formed (see FIG. 8D). The insulating film is formed in a single layer or stacked layers by forming a film of an inorganic material such as silicon oxide or silicon nitride, an organic material such as polyimide, polyamide, benzocyclobutene, acrylic, or epoxy, a siloxane material, or the like by a CVD method, a sputtering method, a SOG method, a droplet discharge method, a screen printing method, or the like. For example, when the insulating film is formed to have a two-layer structure, a silicon nitride oxide film and a silicon oxynitride film can be formed as a first insulating film 709 and a second insulating film 710, respectively.

Note that before the insulating films 709 and 710 are formed or after one or both of them are formed, thermal treatment is preferably applied for recovery of the crystallinity of the semiconductor films, activation of the impurity element that has been added into the semiconductor films, or hydrogenation of the semiconductor films. As the thermal treatment, thermal annealing, a laser annealing method, an RTA method, or the like is preferably applied.

Next, the insulating films 709 and 710 are etched using a photolithography method, whereby contact holes that expose the second n-type impurity regions 706b are formed. Then, a conductive film is formed so as to fill the contact holes and the conductive film is selectively etched to form conductive films 731. Note that before the formation of the conductive films, silicide may be formed on the surfaces of the crystalline semiconductor films 704a to 704d that are exposed by the contact holes.

The conductive films 731 are formed in a single layer or stacked layers of any element selected from aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), carbon (C), and silicon (Si), or an alloy material or a compound material containing such an element as a main component. An alloy material containing aluminum as a main component corresponds to, for example, a material which contains aluminum as a main component and also contains nickel, or a material which contains aluminum as a main component and also contains nickel and one or both of carbon and silicon. The conductive films 731 are preferably formed to have a stack-layer structure of, for example, a barrier film, an aluminum-silicon film, and a barrier film, or a barrier film, an aluminum-silicon film, a titanium nitride film, and a barrier film. Note that “barrier film” corresponds to a thin film of titanium, titanium nitride, molybdenum, or molybdenum nitride. Aluminum and aluminum silicon, which have low resistance values and are inexpensive, are the most suitable material for forming the conductive films 731. When barrier layers are provided as the top layer and the bottom layer, generation of hillocks of aluminum or aluminum silicon can be prevented. Further, when a barrier film formed of titanium which is an element having a high reducing property is formed, even when there is a thin natural oxide film formed on the crystalline semiconductor film, the natural oxide film can be reduced, and a favorable contact between the conductive film 731 and the crystalline semiconductor film can be obtained.

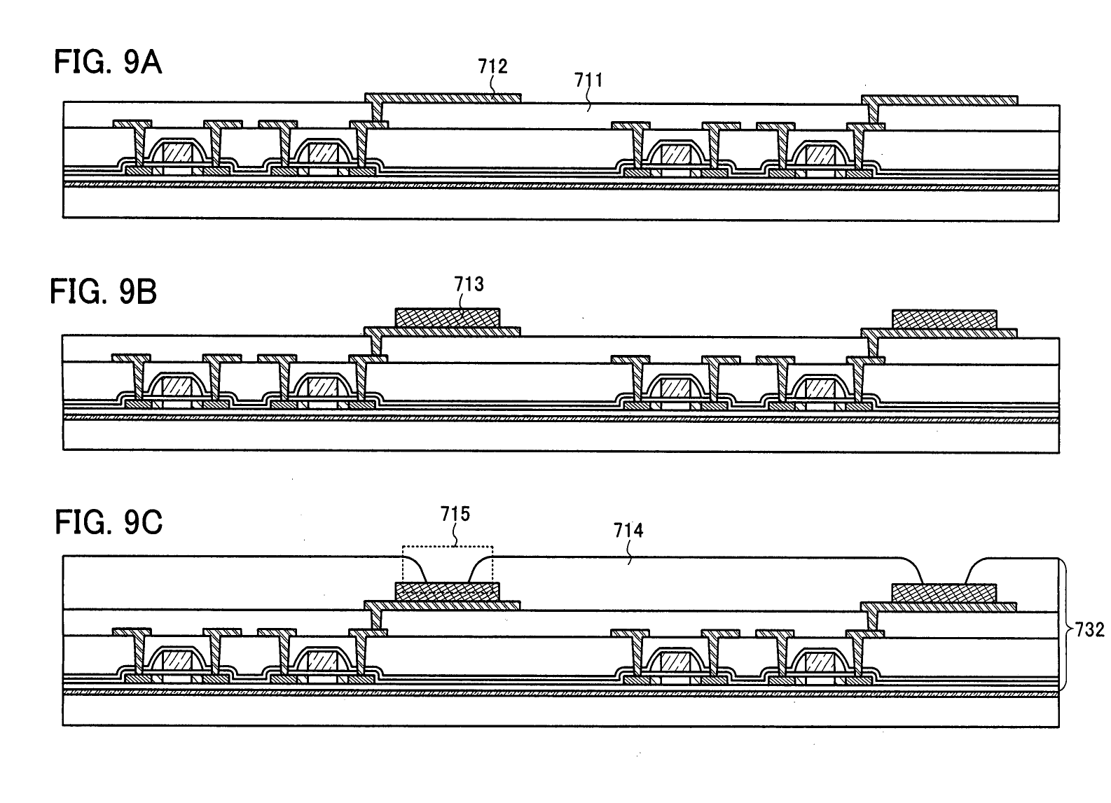

Next, an insulating film 711 is formed so as to cover the conductive films 731, and conductive films 712 are formed over the insulating film 711 so as to be electrically connected to the conductive films 731 (see FIG. 9A). The insulating film 711 is formed in a single layer or stacked layers by depositing an inorganic material or an organic material by a CVD method, a sputtering method, a SOG method, a droplet discharge method, a screen printing method, or the like. Preferably, the insulating film 711 is formed to have a thickness of 0.75 to 3 μm. In addition, the conductive films 712 can be formed by using any of the foregoing materials which are given in a description of the conductive films 731.

Next, conductive films 713 are formed over the conductive films 712. The conductive films 713 are formed of a conductive material by a CVD method, a sputtering method, a droplet discharge method, a screen printing method, or the like (see FIG. 9B). Preferably, the conductive films 713 are formed in a single layer or stacked layers, using an element selected from aluminum (Al), titanium (Ti), silver (Ag), copper (Cu), or gold (Au), or an alloy material or a compound material containing such an element as a main component. Here, the conductive films 713 are formed by depositing paste containing silver over the conductive films 712 by a screen printing method, and applying thermal treatment thereto at 50 to 350° C. Further, after the formation of the conductive films 713 over the conductive films 712, a region where the conductive films 713 and 712 overlap may be irradiated with laser light in order to enhance electrical connection therebetween. Note that it is also possible to selectively provide the conductive films 713 over the conductive films 731 without providing the insulating film 711 and the conductive films 712.

Next, an insulating film 714 is formed so as to cover the conductive films 712 and 713, and the insulating film 714 is selectively etched by a photolithography method, whereby openings 715 that expose the conductive films 713 are formed (see FIG. 9C). The insulating film 714 is formed in a single layer or stacked layers by depositing an inorganic material or an organic material by a CVD method, a sputtering method, a SOG method, a droplet discharge method, a screen printing method, or the like.

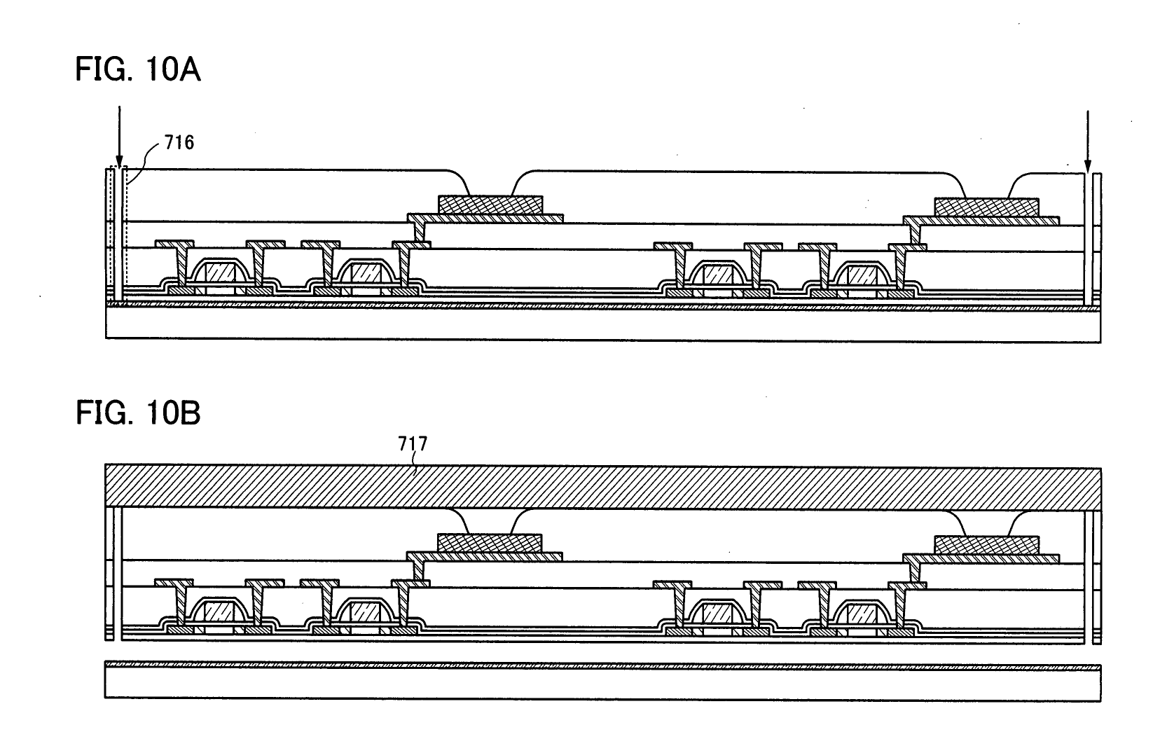

Next, a layer 732 including the thin film transistors 730a to 730d and the like (hereinafter also simply referred to as a “layer 732”) is peeled off the substrate 701. Here, openings 716 are formed by laser (e.g., UV light) irradiation (see FIG. 10A), and then the layer 732 can be peeled off the substrate 701 with physical force. In addition, before the layer 732 is peeled off the substrate 701, an etchant may be introduced into the openings 716 to remove the release layer 702. As an etchant, gas or liquid containing halogen fluoride or an interhalogen compound is used. For example, when chlorine trifluoride is used as a gas containing halogen fluoride, the layer 732 is peeled off the substrate 701. Note that the release layer 702 may be partially left without being completely removed. Accordingly, consumption of etchant can be suppressed, and the time required for removing the release layer can be reduced. Further, the layer 732 may be retained above the substrate 701 even after the release layer 702 is removed. The substrate 701 from which the layer 732 is peeled is preferably reused for cost saving.

Here, after forming the openings 716 by etching the insulating film with laser irradiation, a first sheet material 717 is attached to one surface of the layer 732 (the surface where the insulating film 714 is exposed), and then the layer 732 is completely peeled off the substrate 701 (see FIG. 10B). For the first sheet material 717, for example, a heat peelable tape whose adhesive strength is weakened by heat can be used.

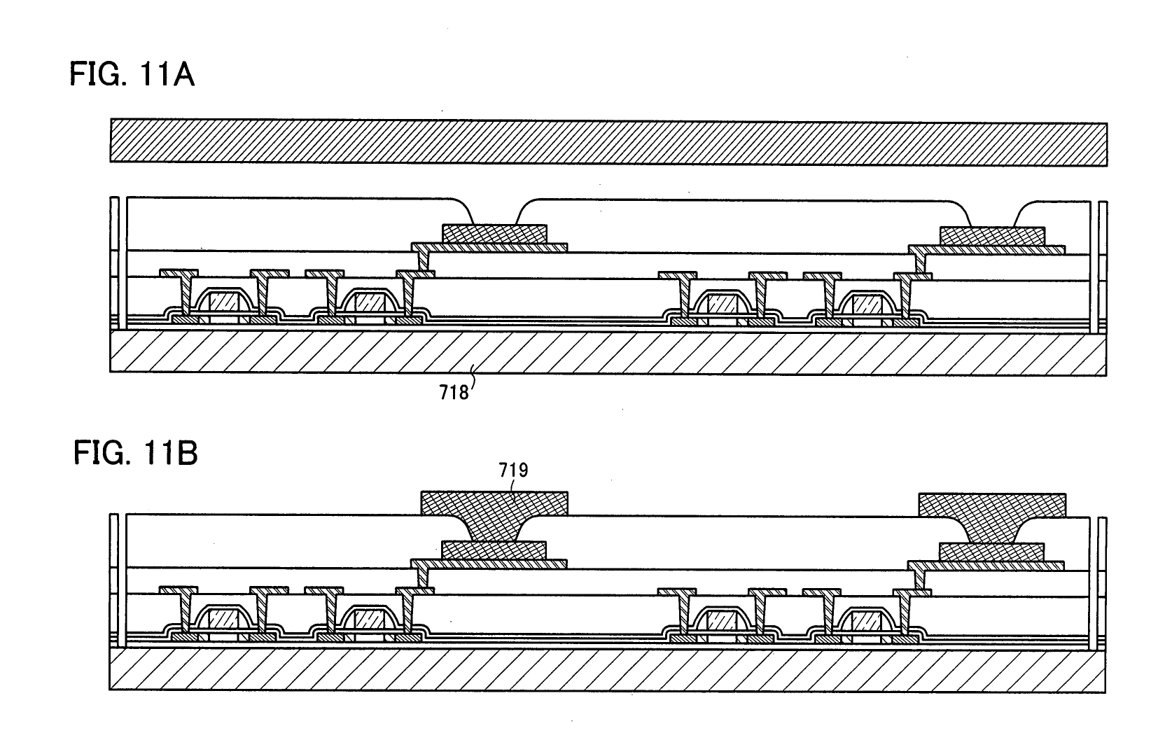

Next, a second sheet material 718 is attached to the other surface of the layer 732 (the surface exposed by peeling), followed by one or both of thermal treatment and pressurization treatment so that the second sheet material 718 is fixed. At the same time as or after the second sheet material 718 is provided, the first sheet material 717 is peeled (see FIG. 11A). For the second sheet material 718, a hot-melt film or the like can be used. In addition, when a heat peelable tape is used for the first sheet material 717, it may be peeled by utilizing heat applied in attaching the second sheet material 718.

As the second sheet material 718, a film on which antistatic treatment for preventing static electricity or the like has been applied (hereinafter, referred to as an antistatic film) can also be used. Examples of the antistatic film include, but not limited to, a film in which an antistatic material is dispersed in a resin, a film to which an antistatic material is attached. The film provided with an antistatic material can be a film with an antistatic material provided over one of its surfaces, or a film with an antistatic material provided over opposing surfaces. Further, the film with an antistatic material provided over one of its surfaces may be attached to the layer 732 so that the antistatic material is placed on the inner side of the film or the outer side of the film. The antistatic material may be provided over the entire surface of the film, or over a part of the film. As an antistatic material, a metal, indium tin oxide (ITO), or a surfactant such as an amphoteric surfactant, a cationic surfactant, or a nonionic surfactant can be used. Further, as an antistatic material, a resin material which contains a cross-linked copolymer having a carboxyl group and a quaternary ammonium base on its side chain, or the like can be used. By attaching, mixing, or applying such a material to a film, an antistatic film can be formed. By sealing the layer 732 using the antistatic film, the semiconductor elements can be prevented from adverse affects such as external static electricity when treated as a commercial product.

Next, conductive films 719 are formed so as to cover the openings 715 (see FIG. 11B). Note that before or after the formation of the conductive films 719, the conductive films 712 and 713 may be irradiated with laser light to improve electrical connection.

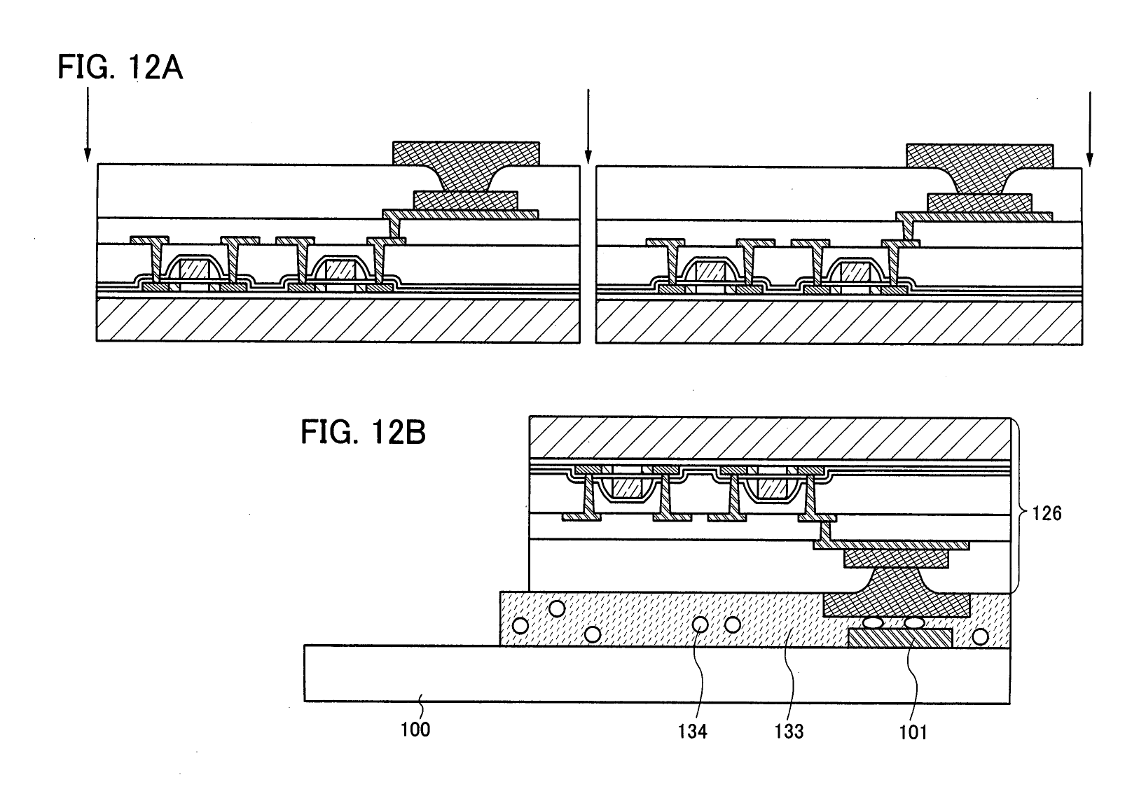

Next, an element group 733 is cut into a plurality of element layers by selective laser irradiation (see FIG. 12A). Through the foregoing steps, the element layers can be manufactured.

Next, the element layer 126 is pressure-bonded to the substrate 100 having the conductor structures 101a and 101b (not shown) serving as an antenna (see FIG. 12B). Specifically, as described in the foregoing embodiment mode, attachment is carried out so that the conductor trace 101a, which is formed over the substrate 100 and serves as the antenna, is electrically connected to the conductive film 719 of the element layer 126. Here, the element layer 126 is attached to the substrate 100 with the adhesive resin 133. In addition, the conductive film 719 and the conductor trace 101 are electrically connected using conductive particles 134 contained in the adhesive resin 133.

This embodiment can be applied to manufacture the semiconductor devices described in any of embodiment modes in this specification.

An antenna used for the semiconductor device of this embodiment mode has a loop-like shape and has a cut portion in addition to a power feeding portion in its conductive structure. Since electric charge can be accumulated in the cut portion, current flowing into the vicinity of the cut portion becomes large. Therefore, unevenness in current density distribution in the conductive structure serving as the antenna is reduced, so that a magnetic field with reduced distortion can be generated in electromagnetic wave transmission and reception to and from the antenna. According to this embodiment mode, a semiconductor device with reduced variation in communication distance and response frequency can be manufactured.

Further, the antenna provided according to this embodiment mode does not use a circuit element and is formed only by a conductive material; therefore, the antenna can be formed in one plane. In addition, an integrated circuit which is connected to the antenna in the power feeding portion is structured by thin film transistors. Accordingly, the semiconductor device can be easily thinned and can be mounted over various products.

Further, the antenna used in the semiconductor device of this embodiment mode has a capacitive component in its cut portion; therefore, when the size of the antenna is adjusted to a certain frequency, inductance can be small. That is, the length of the antenna can be small. Accordingly, the size of the semiconductor device can be small.

### EMBODIMENT MODE 4

This embodiment mode describes a structure of an RFID tag for which a semiconductor device having an antenna described in any of the foregoing embodiment modes is used, with reference to drawings.

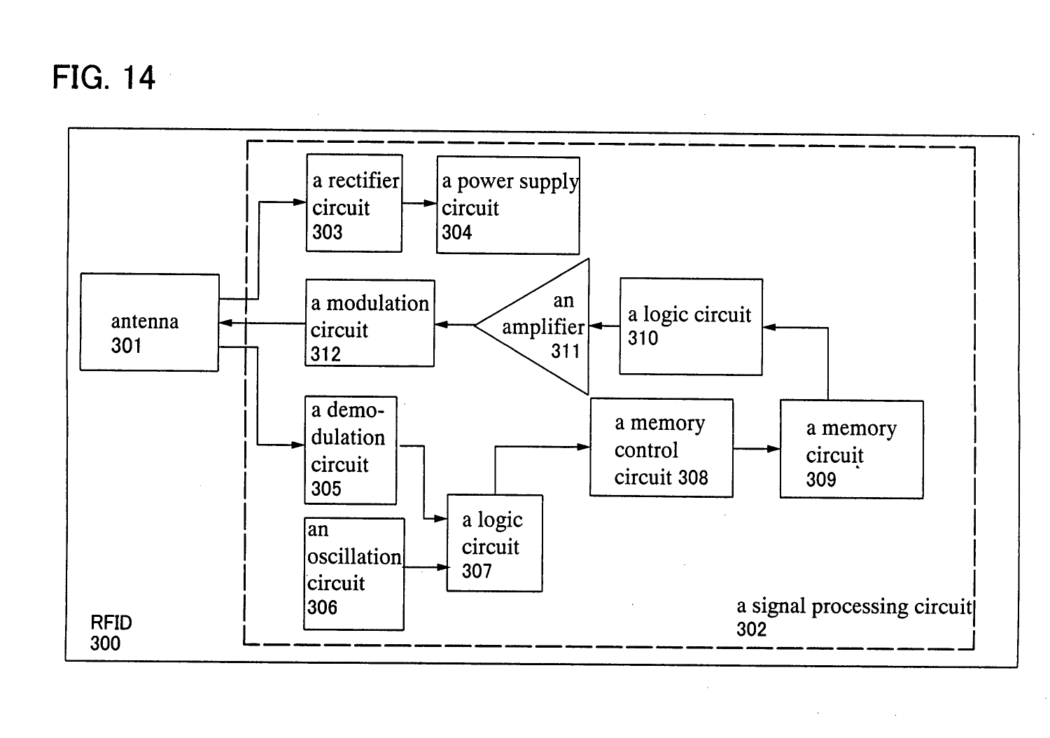

A block diagram of the RFID tag of this embodiment mode is shown in FIG. 14.

An RFID tag 300 in FIG. 14 has an antenna 301 and a signal processing circuit 302. The signal processing circuit 302 includes a rectifier circuit 303, a power supply circuit 304, a demodulation circuit 305, an oscillation circuit 306, a logic circuit 307, a memory control circuit 308, a memory circuit 309, a logic circuit 310, an amplifier 311, and a modulation circuit 312.

Communication signals received by the antenna 301 of the RFID tag 300 are input into the demodulation circuit 305 in the signal processing circuit 302. The frequency of the communication signals received, that is, signals communicated between the antenna 301 and a reader/writer can be, for example, UHF (ultra high frequency) bands including 915 MHz, 2.45 GHz, and the like that are determined based on the ISO standards or the like. Needless to say, the frequency of signals communicated between the antenna 301 and the reader/writer is not limited to these, and for example, any of the following frequencies can be used: submillimeter waves of 300 GHz to 3 THz, millimeter waves of 30 GHz to 300 GHz, microwaves of 3 GHz to 30 GHz, a ultra high frequency of 300 MHz to 3 GHz, and a very high frequency of 30 MHz to 300 MHz. In addition, signals communicated between the antenna 301 and the reader/writer are signals obtained through carrier modulation. A carrier modulation method can be either analog modulation or digital modulation, and any of amplitude modulation, phase modulation, frequency modulation, and spread spectrum can be used. Preferably, amplitude modulation or frequency modulation is used.

An oscillation signal output from the oscillation circuit 306 is supplied as a clock signal to the logic circuit 307. In addition, carriers that have been modulated are demodulated in the demodulation circuit 305, and the demodulated signal is transmitted to be analyzed in the logic circuit 307. The signal analyzed in the logic circuit 307 is transmitted to the memory control circuit 308. Based on the analyzed signal, the memory control circuit 308 controls the memory circuit 309, extracts data stored in the memory circuit 309, and transmits the data to the logic circuit 310. The signal transmitted to the logic circuit 310 is encoded in the logic circuit 310 and amplified in the amplifier 311. With the amplified signal, the modulation circuit 312 modulates carriers. With the modulated carriers, the reader/writer recognizes the signal from the RFID tag. On the other hand, carriers input to the rectifier circuit 303 are rectified and input to the power supply circuit 304. A power supply voltage obtained in this manner is supplied by the power supply circuit 304 to the demodulation circuit 305, the oscillation circuit 306, the logic circuit 307, the memory control circuit 308, the memory circuit 309, the logic circuit 310, the amplifier 311, the modulation circuit 312, and the like. Note that the power supply circuit 304 is not necessarily provided. In FIG. 14, the power supply circuit 304 has a function of stepping down or stepping up an input voltage or inverting the polarity of the input voltage. The RFID tag 300 operates in this manner.

The shape of an antenna included in the antenna 301 may be selected from those described in the foregoing embodiment modes. In addition, a connection method of the signal processing circuit and the antenna circuit is not specifically limited. For example, the antenna and the signal processing circuit may be connected by wire bonding or bump connection. Alternatively, the signal processing circuit may be formed in a chip and one surface thereof may be used as an electrode to be attached to the antenna. In addition, the signal processing circuit and the antenna can be attached to each other by the use of an ACF (anisotropic conductive film).

Note that the antenna may be either stacked over the same substrate as the signal processing circuit 302, or formed as an external antenna. Needless to say, the antenna may also be provided on the top or bottom of the signal processing circuit.

The rectifier circuit 303 may be any circuit as long as it converts AC signals that are induced by carriers received by the antenna 301 into DC signals.

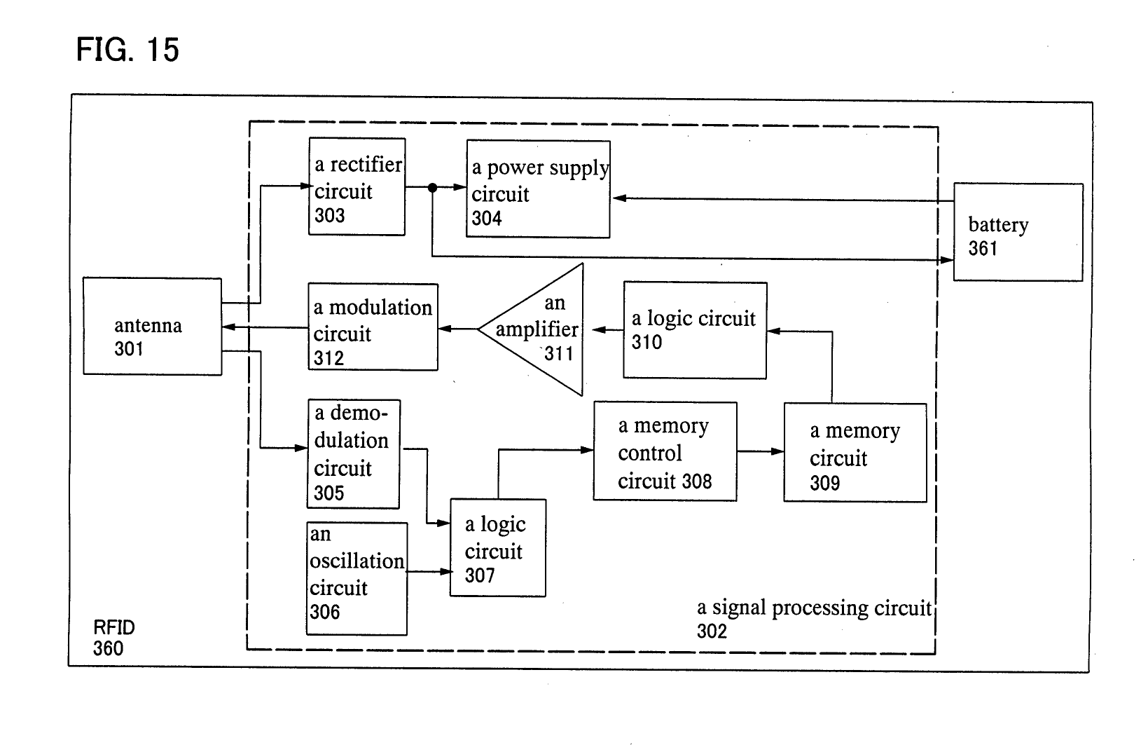

Note that the RFID tag described in this embodiment mode may be provided with a battery 361 as shown in FIG. 15, in addition to the structure shown in FIG. 14. When a power supply voltage output from the rectifier circuit 303 is not high enough to operate the signal processing circuit 302, the battery 361 may also supply a power supply voltage to each circuit of the signal processing circuit 302, such as the demodulation circuit 305, the oscillation circuit 306, the logic circuit 307, the memory control circuit 308, the memory circuit 309, the logic circuit 310, the amplifier 311, and the modulation circuit 312. Concerning energy to be stored in the battery 361, a surplus voltage of the power supply voltage output from the rectifier circuit 303 may be stored in the battery 361, for example, when the power supply voltage output from the rectifier circuit 303 is sufficiently higher than the power supply voltage required to operate the signal processing circuit 302. It is also possible to provide another antenna and another rectifier circuit in the RFID tag, in addition to the antenna 301 and the rectifier circuit 303, so that the battery 361 can be charged with energy obtained from electromagnetic waves and the like that are generated randomly. That is the battery 361 can be charged wirelessly.

Note that “battery” refers to a battery whose continuous operating time can be recovered by charging. Further, as a battery, a battery formed in a sheet-like form is preferably used. For example, by using a lithium polymer battery that uses a gel electrolyte, a lithium ion battery, a lithium secondary battery, or the like, reduction in size is possible. Needless to say, any battery may be used, as long as it is chargeable. For example, a nickel metal hydride battery, a nickel cadmium battery, a large-capacity capacitor, or the like may be used.

This embodiment mode can apply structures of any of antennas and semiconductor devices described in another embodiment mode in this specification.

An antenna used for the semiconductor device of this embodiment mode has a cut portion in its conductive structure. Since electric charge can be accumulated in the cut portion, current flowing into the vicinity of the cut portion becomes large. Therefore, unevenness in current density distribution in the conductive structure serving as the antenna is reduced, so that a magnetic field with reduced distortion can be generated in electromagnetic wave transmission and reception to and from the antenna. Accordingly, the semiconductor device described in this embodiment mode can reduce variation in communication distance and response frequency depending on positions of the semiconductor device with respect to another antenna or an external element which generates a magnetic field can be reduced.

Further, when a battery capable of wireless charging is provided for the semiconductor device of this embodiment mode, charging of the battery provided for the semiconductor device is made easier, so that external transmission and reception of information is possible without replacing the battery due to depletion of the battery over time.

### EMBODIMENT MODE 5

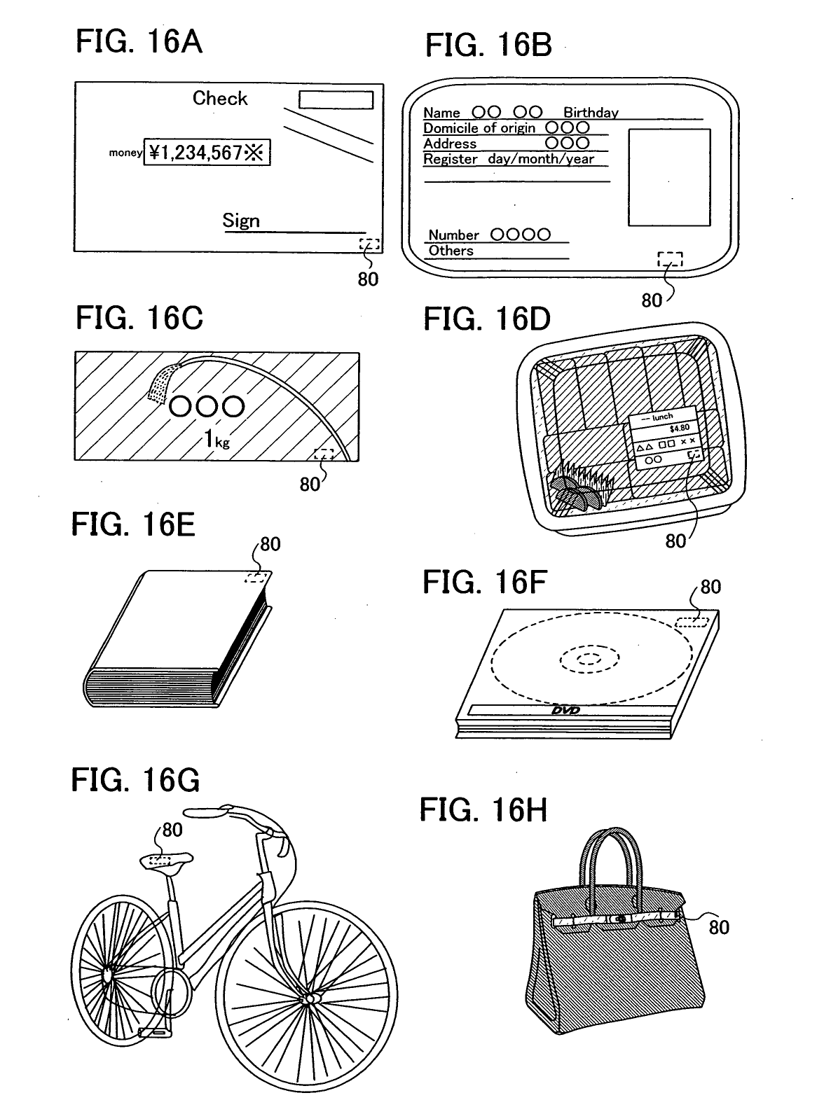

This embodiment mode describes examples of the application of the semiconductor device of the present invention. The semiconductor device of the present invention can be used for various applications, and can be applied to any product whose information such as history can be obtained without contact by the semiconductor device so that the information can be effectively utilized for production, management, and the like. For example, the semiconductor device of the present invention can be applied to bills, coins, securities, documents, bearer bonds, packaging containers, books, storage media, personal belongings, vehicles, foods, clothes, healthcare items, daily commodities, medicines, electronic appliances, and the like. Examples of such application are described with reference to FIGS. 16A to 16H.

The bills and coins are currency in the market and include notes that are circulating as the real money in specific areas (cash vouchers), memorial coins, and the like. The securities include checks, certificates, promissory notes, and the like (FIG. 16A). The documents include driver's licenses, resident's cards, and the like (FIG. 16B). The bearer bonds include stamps, rice coupons, various gift coupons, and the like (FIG. 16C). The packaging containers include paper for wrapping a lunch box or the like, plastic bottles, and the like (FIG. 16D). The documents include books and the like (FIG. 16E). The storage media include DVD software, video tapes, and the like (FIG. 16F). The vehicles include wheeled cycles or vehicles such as bicycles, vessels, and the like (FIG. 16G). The personal belongings include shoes, glasses, and the like (FIG. 16H). The foods include food items, beverages, and the like. The clothes include clothing, footwear, and the like. The healthcare items include medical devices, health appliances, and the like. The daily commodities include furniture, lighting apparatuses, and the like. The medicines include medicament, agricultural chemicals, and the like. The electronic appliances include liquid crystal display devices, EL display devices, television devices (television receivers or thin television receivers), mobile phones, and the like.

When a semiconductor device 80 is provided for bills, coins, securities, documents, bearer bonds, and the like, forgery thereof can be prevented. In addition, when the semiconductor device 80 is provided for packaging containers, books, storage media, personal belongings, foods, daily commodities, electronic appliances, and the like, the efficiency of an inspection system, a rental shop system, and the like can be improved. Further, when the semiconductor device 80 is provided for vehicles, healthcare items, medicines, and the like, forgery and theft thereof can be prevented and wrong use of the medicines can be prevented. The semiconductor device 80 may be provided by, for example, being attached to the surface of an object or embedded in an object. For example, the semiconductor device 80 may be embedded in paper of a book or embedded in an organic resin of a package. When the semiconductor device is provided on paper or the like, damage on the elements included in the semiconductor device can be prevented by providing the semiconductor device which is formed in a small size.

In this manner, when the semiconductor device is provided for packaging containers, storage media, personal belongings, foods, clothing, daily commodities, electronic appliances, and the like, the efficiency of an inspection system, a rental shop system, and the like can be improved. In addition, when the semiconductor device is provided for vehicles, forgery and theft thereof can be prevented. Further, when the semiconductor device is implanted in creatures such as animals, identification of the individual creature can be easily carried out. For example, when the semiconductor device is implanted in creatures such as domestic animals, not only the year of birth, sex, breed, and the like but also health conditions such as body temperature can be easily managed.

Further, this embodiment mode can apply structures of any of antennas and semiconductor devices described in another embodiment mode in this specification so that variation in communication distance and response frequency depending on positions of a semiconductor device which is held over a reader/writer can be reduced. In addition, the semiconductor device can be easily thinned and can be mounted over various products.

### EMBODIMENT 1

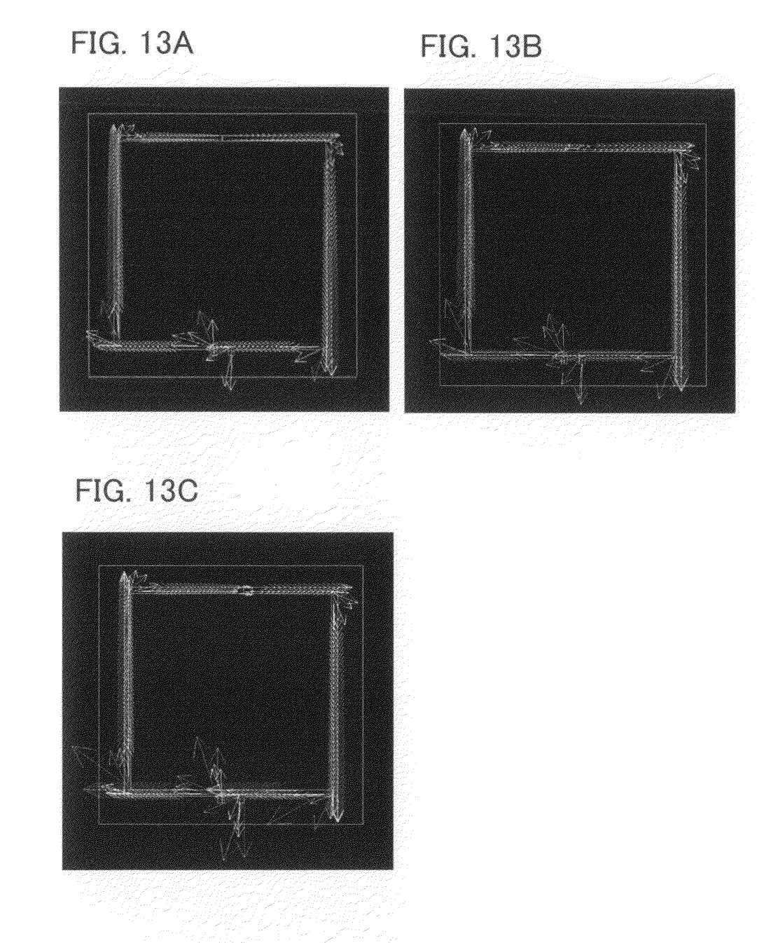

Specific examples, results of an experiment and a calculation, and the like are described below. In specific, examples of calculation results to see a change in current density distribution due to a shape of a cut portion is described with reference to FIGS. 13A to 13C, 17A to 17F, and 18A to 18C.

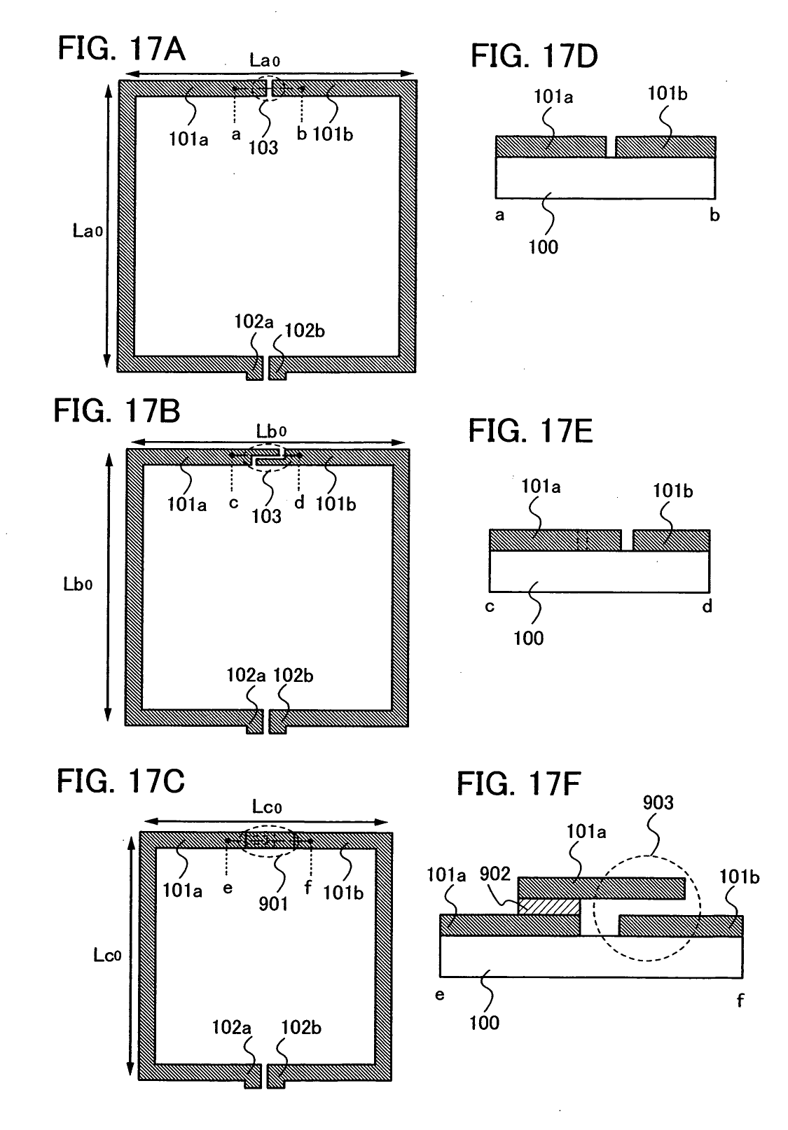

FIGS. 17A, 17B, and 17C each show a shape of the antenna which is used for the calculation. Note that in FIGS. 17A to 17F, FIG. 17D shows a cross-sectional view taken along the line a-b in FIG. 17A, FIG. 17E shows a cross-sectional view taken along the line c-d in FIG. 17B, and FIG. 17F shows a cross-sectional view taken along the line e-f in FIG. 17C.

The cut portion 103 is straight line-shaped. In FIG. 17B, the cut portion 103 has a zigzag shape. In FIG. 17C, the cut portion 103 has an overlapping portion 901, and a perfect conductor without resistance can be obtained according to the calculation. Since a perfect conductor layer 902 is sandwiched, the conductive structure 101 can have a three-dimensional structure, and a parallel plate capacitor can be formed in a region 903. Thus, capacity in FIG. 17C is larger than that in FIG. 17B.

In each of the antennas, Cu with a film thickness of 35 μm and a line width of 1 mm is provided over a substrate of a dielectric material with a thickness of 0.2 mm and a relative dielectric constant of 4.6. The region other than that is air.

The calculation is performed as follows. The shape of the antenna in FIG. 17A is set by changing only lengths of the cut portion 103 and the conductive structure 101 so that the antenna resonates at 915 MHz, and then current density distribution is observed. Similar calculation is performed on each of the antennas in FIGS. 17B and 17C.

In the antenna having the shape shown in FIG. 17A, the size of the antenna which resonates at 915 MHz is a square which has a side Lao of 38 mm. In the antenna having the shape shown in FIG. 17B, the size of the antenna which resonates at 915 MHz is a square which has a side Lb₀ of 36 mm. In the antenna having the shape shown in FIG. 17C, the size of the antenna which resonates at 915 MHz is a square which has a side Lc₀ of 32 mm. Thus, in the antennas having the shapes shown in FIGS. 17A to 17C, as the shapes of the cut portion 103 changes in this order: a straight line, a zigzag shape, and a parallel plate capacitor; the length of the antenna line decreases, accordingly, capacity generated in the cut portion 103 and the overlapping portion 901 increases.

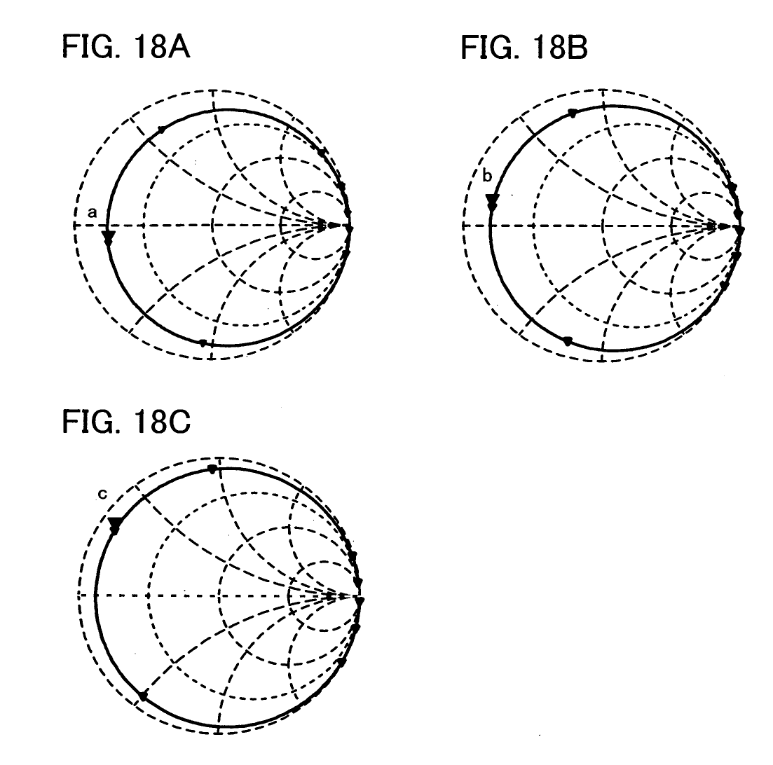

FIG. 18A shows impedance of the antenna in FIG. 17A. FIG. 18B shows impedance of the antenna in FIG. 17B. FIG. 18C shows impedance of the antenna in FIG. 17C.

An impedance of a port of measurement point in the power feeding portions 102a and 102b is 50 Ω and a calculation is made by difference input. Here, an impedance of the antenna having the shape shown in FIG. 17A is 6.672-j4.459 (where j is an imaginary number), an impedance of the antenna having the shape shown in FIG. 17B is 5.414+j4.160 (where j is an imaginary number), and an impedance of the antenna having the shape shown in FIG. 17C is 3.452+j14.425 (where j is an imaginary number).

Next, distribution of current density generated in the conductive structure 101 is observed with a magnetic field simulator.

FIG. 13A shows the calculation result of the model shown in FIG. 17A, FIG. 13B shows the calculation result of the model shown in FIG. 17B, and FIG. 13C shows a calculation result of the model shown in FIG. 17C. In FIGS. 13A to 13C, a direction and a size of an arrow which is seen with the conductive structure of the antenna indicate a direction of current and current density, respectively. In a comparison between FIG. 13A and FIG. 13B, and a comparison between FIG. 13A and FIG. 13C, when sizes of the arrows in the cut portions are compared in particular, the result shows that an antenna with more complicated shaped cut portion and more larger capacity has more even current density distribution. Accordingly, an advantageous effect of the present invention is verified.

Note that a calculation results described here are just examples. The size of an antenna changes in accordance with a line width, a material, and the like.

When the length of the loop antenna is larger than a certain length in accordance with a wavelength, unevenness is caused in current density distribution in the antenna and a magnetic field is distorted. This unevenness can be relieved by capacity of the cut portion 103. When capacity of the cut portion 103 is small, only a small amount of electric charge can be accumulated in the vicinity of the cut portion 103; accordingly, small current flows into the cut portion 103. On the other hand, when the capacity of the cut portion 103 is large, a large amount of electric charge is accumulated in the vicinity of the cut portion 103; accordingly, large current flows into the cut portion 103. Thus, current density distribution in the antenna becomes even. It is apparent that this advantageous effect is more notable when the capacity of the cut portion 103 is larger.

This application is based on Japanese Patent Application serial no. 2006-353243 filed in Japan Patent Office on Dec. 27, 2006, the entire contents of which are hereby incorporated by reference.

What is claimed is:

1. An antenna comprising:
a loop-like shaped conductive structure;
a power feeding portion in a part of the loop-like shaped conductive structure; and
at least one cut portion in another part of the loop-like shaped conductive structure,
wherein cross-sectional surfaces of the loop-like shaped conductive structure in the cut portion face each other,
wherein the loop-like shaped conductive structure has capacity in the cut potion.

2. An antenna comprising:
a power feeding portion;
a first conductive structure extending in a first direction from the power feeding portion; and
a second conductive structure extending in a second direction different from the first direction, from the power feeding portion,
wherein a part of the first conductive structure and a part of the second conductive structure overlap spatially, and
wherein an overlapping portion of the first conductive structure and the second conductive structure has capacity.

3. A radio frequency identification device comprising:
an integrated circuit; and
an antenna having a loop-like shaped conductive structure,
wherein the antenna electrically connects to the integrated circuit through a power feeding portion,
wherein a part of the antenna has at least one cut portion,
wherein cross-sectional surfaces in the cut portion face each other,
wherein the antenna has capacity in the cut potion.

4. A radio frequency identification device comprising:
an integrated circuit; and
an antenna,
wherein the antenna electrically connects to the integrated circuit through a power feeding portion,
wherein the antenna includes the power feeding portion, a first conductive structure extending in a first direction from the power feeding portion, and a second conductive structure extending in a second direction different from the first direction, from the power feeding portion,
wherein a part of the first conductive structure and a part of the second conductive structure overlap spatially, and
wherein an overlapping portion of the first conductive structure and the second conductive structure has capacity.

5. The antenna according to claim 1, wherein the power feeding portion comprises a coil.

6. The antenna according to claim 2, wherein the power feeding portion comprises a coil.

7. The radio frequency identification device according to claim 3, wherein the power feeding portion comprises a coil.

8. The radio frequency identification device according to claim 4, wherein the power feeding portion comprises a coil.

9. The antenna according to claim 1, wherein the conductive structure has a laminated structure including a first metal film and a second metal film.

10. The antenna according to claim 2, wherein the conductive structure has a laminated structure including a first metal film and a second metal film.

11. The radio frequency identification device according to claim 3, wherein the conductive structure has a laminated structure including a first metal film and a second metal film.

12. The radio frequency identification device according to claim 4, wherein the conductive structure has a laminated structure including a first metal film and a second metal film.

13. The antenna according to claim 9, wherein each of the first metal film and the second metal film comprises a metal selected from the group consisting of Cu, Al, Ag, and Ni.

14. The antenna according to claim 10, wherein each of the first metal film and the second metal film comprises a metal selected from the group consisting of Cu, Al, Ag, and Ni.

15. The radio frequency identification device according to claim 11, wherein each of the first metal film and the second metal film comprises a metal selected from the group consisting of Cu, Al, Ag, and Ni.

16. The radio frequency identification device according to claim 12, wherein each of the first metal film and the second metal film comprises a metal selected from the group consisting of Cu, Al, Ag, and Ni.
